(19) United States
(12) Patent Application Publication
(10) Pub. No.: US 2026/0311614 A1
(43) Pub. Date: Oct. 8, 2026

(54) SYSTEMS AND METHODS FOR LAUNCHING INNOVATION

(71) Applicant: RebelBase, Inc., West Hurley, NY (US)

(72) Inventors: Alejandro Juárez CRAWFORD, West Hurley, NY (US); Tuba Erbil, West Hurley, NY (US); Tiffany L. Kwan, East Elmhurst, NY (US)

(21) Appl. No.: 19/697,428

(22) Filed: Jun. 3, 2026

Related U.S. Application Data
(63) Continuation of application No. 17/393,218, filed on Aug. 3, 2021.
(60) Provisional application No. 63/061,029, filed on Aug. 4, 2020.

(51) Int. Cl. G09B 7/02; G06Q 10/063

(52) U.S. Cl. CPC G09B 7/02; G06Q 10/063

(57) ABSTRACT

A method of operating an innovation learning system, that both teaches how to innovate and facilitates development of an innovation, includes presenting to a plurality of the user systems an ordered sequence of builder modules. Each of the builder modules includes educational content related to a topic of the builder, the topic relating to an aspect of teaching how to innovate, and an interface field to receive from the user system entry of an answer to a question related to the development of the innovation. The innovation learning system receives from the plurality of user systems input representing the answer to the question, wherein the input from at least one of the plurality of user systems modifies the input from at least another one of the plurality of user systems. An instruction from at least one of the user systems is received to publish at least one of the builder modules, and in response the innovation learning system publishes the builder module, the publishing providing access to the builder module, including the received input representing the answer to the question, to a selected group of users of the innovation learning system, for feedback on the builder modules from the selected group.

### CROSS REFERENCE TO RELATED APPLICATIONS

This application is a continuation application of U.S. patent application Ser. No. 17/393,218, filed on Aug. 3, 2021, which claims priority to U.S. Provisional Patent Application No. 63/061,029, filed on Aug. 4, 2020, the contents of each of which are hereby incorporated by reference herein in their entireties.

### BACKGROUND INFORMATION

Current systems are not well suited to facilitating the development of innovations. Schools typically use learning systems that combine e-learning content and learning management systems to teach students how others have solved problems in the past—but these systems fail to support experiential learning or build entrepreneurial literacy. These current processes emerged from disciplines like textbook and strategy framework development, courseware and classroom management, and software platform design. However, textbooks, canvases and templates fail to power dynamic communities of innovation. Learning management systems, developed to support conventional courses and classrooms, lack the tools and integrated content to shape iterative, entrepreneurial projects.

Companies use innovation management systems to gather employee ideas in response to open innovation challenges—but these systems lack in-depth tools to teach managers and employees to be effective innovators.

In both cases, existing processes fail to integrate learning directly into innovation, and vice versa. Innovation management software gives organizations, typically large enterprises, the ability to pose innovation challenges, and manage the process of selecting and implementing ideas sourced from their employees or external communities of innovators. The software is designed to catalyze a company's workforce and focus users on the task of generating ideas that can make the company more efficient or competitive. Usually this entails harvesting ideas from the employees and then using the existing R&D or business development systems to turn these ideas into innovations. These systems are not designed to teach people entrepreneurial innovation.

Previously, to develop such skills and the innovative solutions that go with them was the purview of the rare but brilliant professor, the maverick manager, the breakout accelerator. This exception proves the rule: standard processes and tools have failed to equip instructors and managers to generate such results. Such tools and processes were designed to support traditional education and training, which teaches people to bring established solutions to known problems. These processes and tools fail to prepare learners to collaborate to address unsolved problems by developing new solutions. They fail to provide learners with experience launching experiments, refining them based on the results, and drawing resources to them. They leave learners without the skills and experience they need to replace existing systems with ones equal to today's demands.

This failure has stifled the capacity of institutions such as schools, companies, and communities to build 21st century skills. The skills and mindset built through developing innovative solutions, instead of merely regurgitating established ones, have become a matter of survival for today's graduates and rising talent. Thus, a need exists for a system to provide innovation learning that can span this chasm left by legacy platforms and processes.

### BRIEF DESCRIPTION OF THE DRAWINGS

So that the features of the present invention can be understood, a number of drawings are described below. However, the appended drawings illustrate only particular embodiments of the invention and are therefore not to be considered limiting of its scope, for the invention may encompass other equally effective embodiments.

FIG. 1A is a schematic diagram depicting an embodiment of an architecture of the RebelBase Innovation Learning System (ILS).

FIG. 1B is a schematic diagram depicting an embodiment of a computer system that may be used to implement components of the ILS.

FIG. 2 is a flowchart depicting an embodiment of the division of the architecture of the ILS between a front end and a back end.

FIG. 3 is a diagram depicting an embodiment of a network of connections and relationships between users, Projects and Hubs.

FIG. 4 is a diagram depicting an embodiment of a map of the connections between Projects and Hubs in the ILS.

FIG. 5 is a diagram depicting an embodiment of the connection between various users and their actions on Projects, Hub, and Events in the ILS.

FIG. 6 is a screenshot depicting an embodiment of the Project Creation page of the ILS.

FIG. 7 is a screenshot depicting an embodiment of the Project Profile page of the ILS.

FIG. 8 is a screenshot depicting an embodiment of a Builders home screen.

FIG. 9 is a diagram depicting an embodiment of a network describing Builder tracks and modules.

FIG. 10 is a screenshot depicting an embodiment of the Builder Overview page.

FIG. 11 is a screenshot depicting an embodiment of an Intro to Topic.

FIG. 12 is a screenshot depicting an embodiment of a Brief.

FIG. 13 is a screenshot depicting an embodiment of an Inspiration Byte.

FIG. 14 is a screenshot depicting an embodiment of a Workshop instruction page.

FIG. 15 is a screenshot depicting an embodiment of a RebelMap.

FIG. 16 is a screenshot depicting an embodiment of a Tip.

FIG. 17 is a screenshot depicting an embodiment of an Answer Box.

FIG. 18 is a screenshot depicting an embodiment of a Review+Publish page.

FIG. 19 is a screenshot depicting an embodiment of visibility settings.

FIG. 20 is a screenshot depicting an embodiment of a prompt to invite teammates.

FIG. 21 is a chart depicting an embodiment of functionalities each type of project team member can perform.

FIG. 22 is a screenshot depicting an embodiment of feedback on a published Builder.

FIG. 23 is a screenshot depicting an embodiment of a Person Profile page.

FIG. 24 is a screenshot depicting an embodiment of Person Profile visibility settings.

FIG. 25 is a flow chart depicting an embodiment of the Hub and its features.

FIG. 26 is a screenshot depicting an embodiment of the Hub Banner.

FIG. 27 is a screenshot depicting an embodiment of a dialog box to change Hub details.

FIG. 28 is a screenshot depicting an embodiment of the Hub Member invitation box.

FIG. 29 is a screenshot depicting an embodiment of the Hub Admin invitation box.

FIG. 30 is a screenshot depicting an embodiment of a dialog box to edit Hub Member roles.

FIG. 31 is a screenshot depicting an embodiment of the Activity page.

FIG. 32 is a unified modeling language (UML) diagram for Hub Activity.

FIG. 33 is a screenshot depicting an embodiment of the different types of posts in the Hub Activity page.

FIG. 34 is a screenshot depicting an embodiment of an expanded view of a Q+A post.

FIG. 35 is a screenshot depicting an embodiment of an expanded view of an Idea post.

FIG. 36 is a screenshot depicting an embodiment of an Event page.

FIG. 37 is a UML diagram for Hub Events.

FIG. 38 is a screenshot depicting an embodiment of the Hub Events page.

FIG. 39 is a screenshot depicting an embodiment of the event tile shown on the Hub Events page.

FIG. 40 is a flowchart depicting an embodiment of the process to create a new Event.

FIG. 41 is a screenshot depicting an embodiment of a dialog box to create a new event.

FIG. 42 is a screenshot depicting an embodiment of an Event page.

FIG. 43 is a flowchart depicting an embodiment of an overview for the process of running a round.

FIG. 44 is a screenshot depicting an embodiment of an Admin. view of a round tab after adding Judges and projects to a round.

FIG. 45 is a screenshot depicting an embodiment of a Judge's round-scoring progress.

FIG. 46 is a screenshot depicting an embodiment of a Judge's view of a round.

FIG. 47 is a screenshot depicting an embodiment of round-scoring overview page displayed for a Judge user.

FIG. 48 is a screenshot depicting an embodiment of a project-grading rubric displayed for a Judge user.

FIG. 49 is a screenshot depicting an embodiment of a graded rubric.

FIG. 50 is a screenshot depicting an embodiment of a dialog box to invite participants to an event.

FIG. 51 is a flowchart depicting an embodiment of a process flow for an event life cycle.

FIG. 52 is a screenshot depicting an embodiment of the Groups Overview page.

FIG. 53 is a screenshot depicting an embodiment of a dialog box to create a new Group.

FIG. 54 is a screenshot depicting an embodiment of a dialog box to upgrade a subscription plan.

FIG. 55 is a flowchart depicting an embodiment of a process flow for inviting group members.

FIG. 56 is a screenshot depicting an embodiment of a group page view with Projects, Members and Builder Schedule for Administrator (Admin) users.

FIG. 57 is a screenshot depicting an embodiment of default templates from which to choose as Admin user.

FIG. 58 is a screenshot depicting an embodiment of a chosen template with Builders shown on the right.

FIG. 59 is a screenshot depicting an embodiment of a saved custom template page.

FIG. 60 is a screenshot depicting an embodiment of a Builder Schedule as displayed for Admin user.

FIG. 61 is a screenshot depicting an embodiment of Builders within the Schedule with an Add Builders panel.

FIG. 62 is a screenshot depicting an embodiment of an option to save schedule as a template.

FIG. 63 is a screenshot depicting an embodiment of a dialog box to name or overwrite custom template.

FIG. 64 is a screenshot depicting an embodiment of an option to build a Builder schedule.

FIG. 65 is a screenshot depicting an embodiment of a Builder Schedule page with an Add Builders panel.

FIG. 66 is a screenshot depicting an embodiment of Help for user's project progress as being tracked.

FIG. 67 is a screenshot depicting an embodiment of a dialog box to edit Group members.

FIG. 68 is a screenshot depicting an embodiment of adding members to a Group.

FIG. 69 depicts an embodiment of a method of operating the ILS to both teach how to innovate and facilitate development of an innovation.

### DETAILED DESCRIPTION OF EXAMPLE EMBODIMENTS

RebelBase spans the chasm left by legacy platforms and processes. It bridges the gap in both directions: equipping educators to deliver experiential learning, and injecting learning content and functions directly into the process of innovation management.

This solves a widespread and fast-growing problem. Education and industry have turned increasingly to project-based learning and entrepreneurial problem solving. U.S. colleges alone have launched 2,000+ new e-ship programs since 1990. In the workplace, from 2010-2015, the share of industry leading firms with incubators and accelerators rose from 2% to 44%; those with innovation labs went from 5% to 20%.

The spread of project-based learning and entrepreneurial mechanisms reflects a long-term economic shift. A recent survey of 5,000+ global executives in over 48 countries found that today's employers demand skills like flexibility and collaboration. Growth sectors in particular require skills such as critical thinking, problem solving, teamwork, and flexibility, experts have noted. Experiential learning, through entrepreneurial projects, builds these skills. Research suggests that experiential learning, particularly in the entrepreneurship space, develops critical thinking, communication, collaboration and leadership. After the present pandemic, this need will likely intensify, as more and more industries change their models to survive, and huge shifts rock the economy, as, to take just one example, many companies never fully return to physical offices. Today, our education system faces dramatic hurdles in preparing the workforce with the skills they need to be ready for evolving careers. According to some experts, project-based learning introduces students to the “how” instead of just the “what” of learning, which is critical in developing skills for the modern economy.

Thus the skills and mindset built through developing innovative solutions, instead of merely regurgitating established ones, have become a matter of survival for today's graduates and rising talent. Yet prior to the introduction of RebelBase, to develop such skills and the innovative solutions that go with them was the purview of the rare but brilliant professor, the maverick manager, the breakout accelerator. The exception proves the rule: standard processes and tools have failed to equip instructors and managers to generate such results. Such tools and processes were designed to support traditional education and training, which teaches people to bring established solutions to known problems. These processes and tools fail to prepare learners to collaborate to address unsolved problems by developing new solutions. They fail to provide learners with experience launching experiments, refining them based on the results, and drawing resources to them. They leave learners without the skills and experience they need to replace existing systems with ones equal to today's demands.

This broad failure, in the face of the growing need, proceeds at least in part from the way the separate fields of entrepreneurship development, educational technology (EdTech), and innovation management have evolved. Current processes emerged from disciplines like textbook and strategy framework development, courseware and classroom management, and software platform design. But textbooks, canvases and templates fail to power dynamic communities of innovation. Learning management systems, developed to support conventional courses and classrooms, lack the tools and integrated content to shape iterative, entrepreneurial projects. Innovation management software lacks integrated pedagogy to equip regular people to innovate.

### Entrepreneurship E-Learning Content

Experiential learning demands that students have opportunities to experiment with ideas and iterate multiple versions of an idea. This process requires that students have access to content written to propel these types of activities, and, crucially, that these students gain opportunities to engage with an ecosystem of peers and professionals that can give them feedback. This second requirement, in particular, differentiates experiential learning from algorithmic methods. Users participating in experiential education need access to a live ecosystem of people evolving their solutions in real-world contexts. To bring these ecosystems online, experiential e-learning must incorporate community collaboration and social features to facilitate learning and idea development. This is the key to tying the virtual classroom (or workshop) to the real world.

For entrepreneurial experiential learning, entrepreneurs must engage with their customers, partners, advisors, and resource-providers in order to learn to make and iterate a project. Entrepreneurial competency goes beyond the mastery of learned content and the performance of algorithmic tasks. To innovate, one must overcome problems that have yet to be solved. And not only must one find novel solutions to these problems, one must also persuade people to bring time, talent, and resources to flesh out these solutions.

Consequently, entrepreneurial education depends on assessing entrepreneurs'performance in an array of dynamic challenges—including challenges that test their capacity to make the case to ecosystem participants and adapt to feedback from the market. This means that an effective entrepreneurial e-learning system needs mechanisms that prompt interactions between entrepreneurs and their ecosystems, and facilitate engagement between them. Without this, users lack opportunities to build the core entrepreneurial skill of identifying and mobilizing resources behind an emerging solution—the capacity to activate feedback loops and draw supporters to a project.

This entrepreneurial process is pertinent not only to launching businesses, but to a wide variety of economic functions. Mastery of the entrepreneurial method will become a fundamental literacy not only for business degrees, but also for policy, design, engineering, computer science, liberal arts, and other disciplines.

### Learning Management Systems

Existing LMSs fail to enable experiential, project-based learning. Such learning platforms can be effective for traditional learning. Innovation learning, by contrast, should offer systematic opportunities for students to experiment and iterate. This entails incorporating incorrect answers and failures as part of the process in a structured fashion, which conflicts with education that tests for the correct answers that have been established by dominant paradigms. As a result, the tactics for teaching each approach are distinct. Innovation education should ask students to generate and develop original innovations. (Such innovations include not only business ventures per se, but also projects in innovation, social enterprise, and other disciplines that apply entrepreneurial skills to a range of problems and opportunities in industry and society.) More traditional methods merely ask students to assimilate, retain, and sometimes apply existing knowledge.

Given that the approaches are different, the learning management needs of each are different as well. Traditional education demands learning management systems that help instructors evaluate whether students have mastered existing knowledge. By contrast, experiential, project-based learning should require a process that supports experimentation, dynamic feedback loops, and iterative project evolution. LMSs designed for traditional education fail to support these processes essential for learning to solve problems the way entrepreneurs do.

### Innovation Management Software

Innovation management software gives organizations, typically large enterprises, the ability to put out innovation challenges, and manage the process of selecting and implementing ideas sourced from their employees or external communities of innovators. The software is designed to catalyze and focus a company's workforce on the task of generating ideas that can make the company more efficient or competitive. Usually this entails harvesting ideas from the employees and then using the existing R&D or business development systems to turn these ideas into innovations. These systems are not designed to teach people entrepreneurial innovation.

### This Missing Process for Enabling Organizations to Build 21st Century Skills

21st century skills are in demand, even if legacy solutions fail to teach them. Sought-after skills include working on interdisciplinary teams, piloting new products and initiatives, presenting the merits of novel ideas, and modeling their viability in response to social and economic shifts. Students and employees striving to master existing solutions learn skills such as diagnosis, memorization, and application, may be well served by legacy solutions. By contrast, those learning to produce new solutions that replace existing systems in industry and society must master experimentation, creativity, impact modeling, and other skills requisite for seeking, testing, and improving new solutions. In short, they must master the entrepreneurial process.

Despite the demand, the market has failed broadly to produce these skills. What has been missing is a platform that could effectively:
1. Knit entrepreneurial e-learning content into the process of project collaboration
2. Engage a collaborative ecosystem around it to stimulate project development and evolution
3. Provide educators and administrators with a modular process they could use to power innovation learning for students, citizens, and employees.

Schools that must prepare graduates for the 21st century, and organizations throughout the economy, to survive, must equip their people to innovate in the face of change. Both need an Innovation Learning System (ILS)™ that lets people learn by doing, as they conduct live experiments using the tools of the entrepreneur.

To fill the gap, RebelBase puts the innovation in learning and the learning in innovation.

### The First Innovation Learning System

RebelBase is an innovation learning system (ILS) that injects skills and supports directly into the process of innovation, via a platform any school or organization can adopt. It enables students to mount live, entrepreneurial experiments and learn by doing. To develop a process for experiential education, RebelBase has created a systematic process for attacking pressing problems and replacing inferior solutions. It enables innovators to launch live experiments as they attempt to solve those problems and make those inferior solutions obsolete. It breaks down launching a new solution into simple steps, with interactive guidance, so innovators learn as they build. It then enables the iterative process by which users test, refine, and make the case for innovative solutions, with feedback and assistance from peers, instructors, and expert users rolled into the process of developing a project. In short, it has developed the first innovation learning system.

The RebelBase Builders deliver this guidance within a scalable platform for live project collaboration, so potential innovators learn to work on diverse teams, with feedback from instructors and peers. RebelBase Hubs give communities a basis for engaging their members around emerging innovations. RebelBase Groups give instructors and facilitators tools to guide innovation learning online and off, manage deliverables, and support workshops and engagement. And RebelBase Events let them facilitate feedback, manage demonstrations and competitions/selections, and evaluate results. Because the system builds interactive guidance, evaluation, and support directly into the process of developing an innovation, anyone can learn to attack vexing problems and inadequate solutions the way entrepreneurs do.

To learn entrepreneurial problem solving requires practice developing experimental solutions, testing them in the real world, and incorporating feedback through an iterative process. To this end, the platform leverages community knowledge to produce, critique, and strengthen ideas with accessible learning that innovators can use to build skills as they work to revamp inadequate systems around them. The digital ecosystem tools in RebelBase's platform are fully integrated with the content and feedback loops required to learn innovation and practice the skills and methods it requires. RebelBase's Hub Activity Page is not only a place for students and employees to interact with and learn from a community of professionals, it is also a place for Hub Administrators (Admins) to measure and manage a community's efforts to innovate. In this way, RebelBase gives innovators a collaboration space they can use to test and improve their ideas.

For instructors and process facilitators (both at universities and incubators and at accelerators, competitions, innovation labs, and chambers of commerce), RebelBase provides a simplified way to manage schedule, assignments, communication and evaluation. This structures and simplifies students' experience of interacting with course content, deliverables, and administration. In stark contrast to existing learning management systems, RebelBase enables project-based learning, that teaches students and employees to solve problems in the manner of entrepreneurs. It is precisely this kind of learning that not only launches real entrepreneurs and innovators, but also builds the “21st Century Skills” mentioned above.

### Structured Innovation Learning

RebelBase paces project users (i.e., innovators, or “Rebels”) through a set of educational modules that show them how to build projects for their innovations. At the same time, the platform allows these users to interface with a network of Supporters that can give them feedback on their developing projects, whether these are peers, designated coaches, alumni and other members of a university's innovation ecosystem, or individuals such as industry experts, whom innovators or instructors/facilitators have invited to their hub.

Together, these components supply users with the critical ingredients for an innovation education program: interactive guidance, ongoing collaboration and critique, and access to an ecosystem of support.

To make this possible, RebelBase combines an interactive textbook with a platform for building and evaluating entrepreneurial projects, and an engine for remote collaboration between teams, facilitators, and innovation ecosystems. The platform enables educators, administrators, and managers to go well beyond what is possible in traditional project collaboration, to interact through a systematic approach to entrepreneurship and innovation based on an experiential learning paradigm. For innovators, this provides access to the experience of attempting to launch experiments that replace inadequate systems the innovator identifies. At the instructor level, it equips users to select learning sequences specific to their courses, supported by interactive learning modules that culminate in assessable project outputs.

It allows a web of users, including students, employees, community members, and other participants in other forums for experiential learning such as courses incubators, innovation labs, and competitions, to participate in the wider community of the hub. This lets subscribing organizations engage users such as alumni, industry partners, and potential employers, and permits members of the community to convene and work together with access to the learning modules, collaboration tools, and networking functionality.

Platform users learn to build a solution through a series of interactive learning modules called “Builders.” Each Builder guides users in learning concepts they then apply through an accompanying workshop, which enables them to dynamically update their project profile accessible to other users on the system, opening up access to an ecosystem of feedback and support. As they learn how to think in new ways, teams collaboratively answer questions at the end of each workshop. This process culminates in “publishing” results for each Builder, which then forms part of a cumulative project profile.

### The RebelBase Builder System

RebelBase guides users through a series of learning modules. (These modules are designed for use by students, employees, entrepreneurs, and others. Since all of these users undergo a learning process, in some places we refer to users building projects as “students,” though we could as easily call them “innovators.”) These interactive Builders cover topics such as problem definition, prototyping, landscape analysis, and theory of change modeling, to name a few. They enable users to participate in a set of asynchronous interactions, which create project-outputs that then be used as a basis for synchronous interactions, in-person or via videoconferencing tools They are designed to educate users on how to answer the major questions that they must address to develop a project that can launch as a viable venture or initiative. These questions push users to think about the strategic decision that will make or break their projects. Examples include: “What gets you taken seriously next to your competitors—and what sets your solution apart or changes the game?” and “What concrete results spell the change you're looking for?”

To promote accessibility to aspiring entrepreneurs of any educational level or background, Builder content is carefully constructed to be free of jargon, written in an encouraging and casual style, and mindful to combine step-wise instruction with room for creative freedom. Each Builder guides users through a further step in the entrepreneurial process, helping them internalize concepts as they first learn about them, then apply them to their entrepreneurial pursuit.

The questions in the Builders act as prompts to challenge users to conduct research and generate answers. They also provide learning content that gives users concepts, examples, and techniques for responding to the prompts. While the Builders include content such as Introductions and Tips on Answering that help orient users, the core of the Builders'learning content breaks down into four types: Briefs, Inspiration Bytes, Workshops, and RebelMaps.

Briefs teach entrepreneurs the concepts and frameworks of entrepreneurship and social enterprise to use these to organize their thinking. Inspiration Bytes give users real-world examples that illustrate the concepts and frameworks they learn in the Briefs. This is critical to support applied, experiential learning that builds the muscles (i.e., fosters the skills, knowledge, and mindset) required to solve emerging, unsolved problems, as opposed to spitting back canned solutions that worked in the past. Workshops give users actionable steps they can take to purposefully think-through or research answers to the questions. Finally, Workshops are often accompanied by worksheets called RebelMaps that contain useful visual representations of the concepts, frameworks, and exercises that users learn in the other parts of the Builder.

The Builder System has further attributes that address the unmet need for innovation learning. For one, the Builders are highly modularized. In other words, the tasks of learning, brainstorming, researching, and drafting answers are broken down into small, manageable steps. This process enables the user to avoid overwhelm and focus on answering clearly framed questions and completing well-defined tasks.

Each task is supported by accessible briefs and inspiration bytes, these arm users with essential conceptual tools so that users who understand problems but do not have prior knowledge of entrepreneurship can still complete the tasks laid out in the Workshops. Furthermore, intuitive worksheets—called RebelMaps—give users a common format for mapping out their solution to each builder.

The Builder System is sufficiently modular to support courses of various topics (from social enterprise to intrapreneurial innovation) and of various lengths (from semester-long courses to short boot camps). At the same time, it has proven successful in providing consistency across various undergraduate, masters, and incubator-based learning formats when projects from these heterogeneous formats have competed against each other in competitions.

Uses at both universities and enterprise entrepreneurship and innovation programs have received high ratings among active users, as more intensive distance learning have become requisite.

This results in the first modular, structured process for learning to attack a variety of problems using the tools of the entrepreneur to launch live experiments that attempt to replace inferior systems.

Briefs and Inspiration Bytes: The Builders' Briefs and Inspiration Bytes are designed to be simple and usable. They do not contain lengthy arguments or drawn-out discussions of the merits of one approach versus another. Instead, they take knowledge from the vast worlds of entrepreneurship and social enterprise, and they condense it down into its essentials. In this way, the content is accessible to users of a range of backgrounds and educational levels. MBA's are not necessary prerequisites.

Workshops and RebelMaps: The Builders' Workshops and RebelMaps are highly action-oriented. They give users concrete steps to take to think-through or research answers to the Builders' questions. Actions could include interviewing potential users, analyzing a competitive landscape to identify a differentiator, or recruiting advisors to share their industry knowledge. The directions are clear, but there is no single correct answer. The builders guide users to access resources in order to build their solutions, and then provide a structured format for feedback, iteration, and comparative evaluation of the results.

Structured Process for Learning by Doing: This Builder System gives users structured guidance to learn how to find their way to an innovation when there are no clear cut answers. The types of content, the modularization, the accessibility, and the action-orientedness are the elements that give RebelBase its power as a method and tool for structuring innovation education. Users learn how to think entrepreneurially and make the case for their innovations, not by reviewing cases and books on theory, but rather by picking up the essentials and putting them into action.

Throughout the Builder System, users are not only taking steps to develop innovations, with frameworks and concepts built into the process. They also refine their work iteratively with input from peers, instructors, coaches, and others. Thus learning happens through the sticky process of engaging with the world and managing uncertainties beyond the textbook, slide deck, and white board, turning the learning process into a digitally enabled “laboratory” vital to innovation education.

### A Process for Learning Through Testing, Feedback and Iteration

Rather than learn in isolation, teams tap into their RebelBase hub to test and refine their projects with input from instructors, peers, subject-matter experts, and mentors. As they collaborate, solicit feedback, and garner critical project inputs, they improve their projects using robust mechanisms for iteration. This process of iteration with input is crucial to entrepreneurial problem solving.

Users cannot learn to be experienced innovators by simply brainstorming answers in isolation. Innovation, especially as applied to pressing problems in industry and society, is a collaborative process that results from interaction among teams and between teams and their broader ecosystem. This means that users need to learn to collaborate with peers to generate answers and to network with an ecosystem to elicit critical feedback. Without this ability, not only will they not learn to harness the power of creativity that comes from a team's diversity, but they will also not learn how to validate their ideas against the market.

RebelBase takes this dynamic—the need for social innovators to access an ecosystem of collaborators—into account and gives users tools to facilitate networking and collaboration. As the user progresses through the learning modules, that user encounters a social network of potential collaborators. These collaborators could be others developing their own ideas or Supporters who joined the platform to help users refine and improve their ideas. These collaborators are brought to the platform either by instructors organizing innovation programs or existing users recruiting Supporters. And once users are on the platform, they can engage collaborators in four ways.

Notably, this combination of engagement mechanisms enables users to designate which aspects of their innovation they share, and with whom. This gives users rich capability to reserve work-in-progress and “secret sauce” elements for selected project supporters, members of a class or cohort, evaluators of a demo day or event, members of a larger community, or anyone with a link to their project. That flexibility both supports the combination of engagement and privacy innovation required, and also supports the “mating dance” involving collaborators, advisers, and funders.

Project Supporters: First, they can invite Supporters to be part of a project. Supporters will work with the rest of the project team to create and edit a Project Profile. The Project Profile is an essential piece of RebelBase's collaboration mechanics. It combines aspects of a business plan and a social media profile for an emerging innovation. As teams complete their builders, they publish them to their Project Profile. This becomes searchable, and the answers that display to a certain viewer depend on where the team has published its project. For example, if the team has published a given builder as “team only,” only team members and Supporters will see that builder in the profile. If the team has published to a given event, then Judges and other competitors in that event will see the builder as soon as it is published. If the team has published to a hub or group, then anyone in that community (such as a university, company, or incubator) can see the answers. Project teams select the privacy settings for each builder they publish to their Project Profiles. Sometimes they may only want their immediate team to see their answers. At other times, they may want the answer to be visible to the public.

Builder Notes: When a Project Profile is visible to the public, users can draw on the second type of collaboration dynamic. Project Profiles have built-in spaces for people to write notes on and give kudos in response to a team's published answers. This means project teams can share their Project Profiles with Supporters and ask for their feedback. Project teams can then take this targeted feedback and use it to improve their initial answers.

Hub Activity Feed: A third way to use RebelBase collaboratively is to share posts on an online discussion forum called the activity feed. Each subscribing community (called a Hub) on RebelBase has a shared activity feed where all affiliated innovators and Supporters can share posts, ideas, questions, feedback, and offers to help. For example, a student that's planning to create a prototype could post his initial ideas about the prototype design to the activity feed. Other students, professors, and mentors who are part of the Hub advise the student on how to improve the prototype design before the student invests too many resources into building it. Or perhaps a user wants to learn more about the advantages of different competitive strategies. She can ask about this in the activity feed and receive answers from the community. In sum, the activity feed is where an entire community can collaborate online around the shared goal of producing innovation.

Hub Member Cards: Finally, members of a RebelBase Hub can collaborate by using the Members Page. This page contains Member Cards for everyone who is part of a RebelBase Hub. The cards designate whether a member is a Rebel, a Supporter, a Judge or an Administrator. Rebels are innovators working on a project, and their projects will be listed on their cards. Supporters are any members who joined a Hub to volunteer their expertise to help innovators, and their cards will list their skill set along with an email address where they can be contacted. Administrators are instructors or others responsible for managing a hub, and their role will be listed on their cards. Users can use this page to search for other innovators whose project they might want to join or for Supporters whose skills they need to advance their projects. This page gives them the information to find and contact potential collaborators. Judge cards are available only to users who are invited to an event as a Judge/evaluator.

In conjunction, the Builders and collaboration tools deliver an educational method that enables users to learn skills through action and engagement. It also provides users with a means for generating and refining innovative ideas through experimentation and iteration. These qualities distinguish this innovation learning management system from conventional learning management systems. The method structured by RebelBase guides users to learn how to solve problems through innovation rather than through the application of established knowledge. It does this by equipping users to engage in project-based learning, experiential learning, and/or real-world learning. In other words, it enables users to learn to be innovative by equipping them with the tools to be action-oriented, experiment with new ideas, collect and respond to feedback, and iterate their ideas. As they do so, they build the skills they need to become social innovators.

### Course/Cohort Management and Structured Evaluation

RebelBase provides a structured learning experience for the process of developing an innovation. It also provides tools for instructors to manage their project-based courses, incubators to manage their cohorts, chambers of commerce to manage their client businesses, and enterprises to manage their innovation labs.

RebelBase gives instructors and facilitators three tools that simplify their lives and make them more effective educators. First, RebelBase Groups gives instructors and facilitators a way to set a course schedule and monitor their users as they develop their projects. Second, RebelBase Events gives instructors and facilitators a way to organize competitive events for their courses, adding an element of real-world stakes to the learning experience. Third, RebelBase gives instructors rubrics and a structured format (that the system can automatically populate) for evaluating projects, greatly increasing evaluation efficiency and consistency. These tools come together in a single platform that's uniquely suited to support instructors leading innovation education programs and facilitators of incubator, accelerator, and bottom-up innovation programs.

Groups: RebelBase Groups is a course/workshop management tool that seamlessly integrates with RebelBase's Builder System and allows instructors (including Administrators and Managers) to track the evolution of live projects. This capacity to schedule, monitor, and evaluate live projects as they evolve is distinctive to an innovation learning system. It caters directly to evaluators' need for mechanisms to help them assess a project that is constantly growing and iterating.

Groups integrate with the Builders because Hub Administrators can set a schedule of Builders directly into a Group. They can do this by either choosing a template or building a schedule from scratch. The templates have pre-selected builders tailored to a particular theme and ordered in a logical sequence. For example, the template titled “Social Innovation Basics” includes a set of Builders that are well suited to introduce someone to social innovation. If the existing templates don't quite match the instructors' needs, then they can create a schedule from scratch. Optionally, instructors can add due dates and times to the Builders, so that the members of their Group know the due date by when they should have completed work on their Builders.

Group Administrators (instructors) can easily monitor user progress and access their projects. A Group will display all projects associated with that Group, and each project will have a progress tracker that shows whether group members have started or completed their assigned Builders. This view makes it easy for instructors to keep track of their cohort and visit their project profiles to evaluate their work.

Events: RebelBase Events provides instructors and other Administrators with streamlined tools for organizing project demonstrations, whether they take the form of demo days, pitch events, funding opportunities, or social innovation competitions. These events could be set up as educational exercises or as opportunities for winners to earn real prizes. Either way, the experience of participating in competitive events like this helps users build skills.

One can participate in a RebelBase Event in multiple roles. Competitors associate their project profiles with the event so that anyone involved in the event can see who is competing and with what innovation. Judges upload bios so that competitors and other participants can browse through these and understand who will be evaluating their projects. Supporters volunteer to make themselves available to competitors that may want extra help. And sponsors contribute resources to the event in exchange for having their logo displayed on the event page.

Event organizers can invite anyone to participate in an event, whether or not they are affiliated with a RebelBase Hub. Events can have multiple rounds, where Judges evaluate projects and select winners to move on to later rounds until the event culminates in a final round.

### A Structured Basis for Project Evaluation

Rubrics: Judges—whether they are instructors, funders, managers, or competition Judges—evaluate competitors in a round by examining their project profiles and using a built-in rubric to score the projects. The platform automatically tallies the scores and displays the results. The results will only be visible to Administrators unless they are published to everyone in the Event. This way, if the Judges want to override the decision that would be suggested by the numerical scores, they can.

The parallel structure project profiles in a given event is critical for evaluation consistency and efficiency. RebelBase provides a standard format for users, one that enables the seamless connection of online and offline uses, such as the completion of assignments remotely that can then be critiqued in a video or in-person session, and the engagement of a geographically removed community of peers, experts, and facilitators. Users across the platform are invited to answer the same set of questions for the same set of Builders. And users in a Group are invited to respond to an even more well-defined set of Builders. Moreover, evaluators can use a common rubric to evaluate projects, encouraging different evaluators to look at different projects using a shared lens.

Though there is flexibility in how users answer the questions, the consistency promoted by the Builder System (which gives everyone access to a common set of questions and tools) and rubric makes it easier to compare innovations. This way, evaluators can be confident that they are approaching each project similarly, reducing bias and enabling projects to shine based on the merits of their ideas rather than irregularities in presentation or comprehensiveness.

RebelBase's Groups, Events, and structured evaluation features give educators a toolkit for managing innovation education programs. Groups give Administrators and instructors a means for tracking deliverables that are iterative by nature, making it easier to organize and monitor a program or course in which users are encouraged to experiment and pivot. Events give Administrators a tool for introducing competition and real-world stakes into the program, pushing users to gain experience pitching under pressure. And RebelBase's structure evaluation features bring consistency and efficiency to the process of evaluating innovations, reducing the bias that can creep into evaluations of this sort.

### Fueling and Simplifying Innovation Education

Teaching people to apply existing knowledge is a far cry from equipping them to innovate. Correspondingly, innovation education has a unique set of challenges relative to other forms of education. Users seeking to master skills like experimentation, creativity, and modeling the potential of an innovation require a high degree of flexibility in their projects in order to get the requisite practice. At the same time, programs intended to foster innovation need structure. RebelBase meets both these needs by providing a structured process for developing, managing and evaluating flexible projects. Using the RebelBase method and platform, users receive guidance and support to generate and test ideas. The Builder System lays out a collection of questions that challenge users to think creatively, critically, and strategically about their innovations. The Builders also give users the knowledge they need to research and organize their thoughts to respond to these questions. As they craft their responses, users also have access to ecosystems of Supporters who can give them feedback to help them iterate and refine their projects. With this structure underneath them, users can experiment and learn by building out innovative projects.

The RebelBase platform makes this process widely accessible, enabling positive network effects and making the productive interaction between users across contexts and locations possible, thereby opening up the possibilities for cross-pollination between projects, models, applications of those models, and lessons learned. Through the process built into the platform, instructors and facilitators gain the tools to manage courses and evaluate projects. The platform gives them the tools to track projects that are constantly developing and iterating, making it easier for them to manage the flexibility their users need in order to learn. RebelBase also equips instructors with features for organizing events that tie courses to real-world competitions, opening up more opportunities for users to learn to perform under pressure. Finally, RebelBase's common format for projects, along with its evaluation rubrics, promotes consistency and efficiency across projects and evaluations.

### Additional Components of the Innovation Learning System

User accounts that enable individuals to utilize various modules to learn and apply concepts, attend workshops, network with peers, enter events, and provide and receive feedback to/from peers, experts, professors, and competition judges
   These modules may use everyday language and gaming techniques to make them more accessible to non-specialists.
organization of innovation development into modules with multiple sub-components (Builders) which can be tracked for progress and mapped visually (RebelMaps)
   This includes tools for teams to collaborate and work together on their ideas and innovations, including but not limited to simultaneous editing and presentation (for instance to users in different locations), and areas to associate comments and suggestions near their applicable content.
   This introduces steps and plain language concepts and examples directly into the process of building out the innovation, precisely at the point they're needed.
   This may include modules to provide feedback to users and groups to improve their ideas and innovations.
Matching resources to users and groups to each other or other resources while maintaining confidentiality of proprietary ideas
   This can include a system to rate users by their tenure and/or success and to rank the users. These user rankings can then be used to rate individual projects and ideas (for instance the reviews/opinions of higher-ranked users can be weighted more than lower-ranked users).
   This can include an activity feed where the system coordinates comments, suggestions, and other feedback and insights so that they are displayed near the most appropriate content component entered by the users.
   This can include matching systems facilitated by “member cards” which include key user attributes and profiles.
Users can earn “badges,” certifications, and certifications based on their progress through workshops and modules and their experience developing innovations and success with their ideas and innovations
Workshops which utilize traditional and experiential learning techniques to teach users how to ideate an idea and develop this idea into an innovation
Security systems to ensure that proprietary information is kept confidential and is only accessible to approved users such as Administrators and Judges
Artificial intelligence systems to match users to each other or other resources to facilitate the development of an idea or innovation, including but not limited to machine/algorithmic matching of comments, suggestions, and potential resources/relationships to users and groups
Facilitating competitions and judging events to foster innovation, innovation skills and mindset, and innovation development
   This may utilize the innovation organization and development methods to facilitate the comparisons of projects and proposals to each other and to judging rubrics.
   This may use machine systems to organize each submission so that component parts are displayed together with the judging rubric and other submissions.
   The judging systems can be organized so that individual Judges can instantaneously see other Judges' comments, suggestions, and ratings even if they are not at the same physical locations. This may facilitate and improve judging by easing consensus-building with respect to how to apply rubrics and how each submission compares against the rubric and other submissions.
   These competitions may incorporate insights from the innovation development system including peer reviews, ratings, and rankings, expert reviews, ratings and rankings, time spent on the innovation development system, government and industry data on markets and technologies, and other indicators as the system may record.
Analyzing the skills and other attributes attained by users of innovation development systems
   As users use an innovative development system they build skills in innovation development. The system can record, collect, and analyze the skills that are built based on factors stored in the system like time spent on the system; peer reviews ratings, and suggestions; expert reviews, ratings and comments; Supporter reviews, ratings and comments.
   The process may include a system for certifying the skills and mindset users demonstrate, and transmitting that certification to various stakeholders including funders and employers.
   The system may include dashboards and training for instructors, facilitators, and others to make use of assessments, both for formative purposes, as they assess student progress to provide feedback and calibrate instruction, and for summative purposes, as they evaluate skills built. The skills to which we refer include interpersonal and intrapersonal competencies for communication and collaboration, along with cognitive skills such as critical thinking, problem solving, and decision making. The system may automate assessment features within analytics dashboards available to organizational subscribers, and use analytics to guide and inform practice.
   The system may capture an array of other attributes based on data users opt in to disclose about themselves and their projects, including but not limited to mindset (for example, comfort with risk, confidence producing a solution of their own, preparedness to work on diverse teams, capacity both to provide and to embrace constructive criticism, willingness to revise assumptions in the face of evidence, and other factors), level of engagement and morale, and other characteristics.
   The system may also measure attributes of an innovation ecosystem, including but not limited to skills, support, resources, and other assets made available to innovators, levels and quality of interaction, promising innovations produced, and factors that correlate with career opportunity, economic development, job generation, and other factors. The system may include dashboards and training for instructors, facilitators, funders, and others to make use of these additional metrics.
Matching innovations with supports and financing sources
   The platform captures opt-in data on a variety of factors, from assessments by subject matter experts on the platform to how project ratings improve across iterations.
   As users “publish” their work, the platform provides a basis for matching them and their projects to key supports and financial resources in their community and beyond—from resource providers whose criteria for industry, stage, and various team and solution attributes match those of the published project.
   This reduces the information asymmetry around private projects and simplifies the often hit-or-miss process of learning the attributes of emerging innovators and their innovations within a community and across the user base.

Together, component parts of the RebelBase process enable innovation learning in a way that has simply lacked a process accessible to instructors and administrators at universities, companies, and economic development organizations everywhere. At a time when we have failed to prepare a generation with the skills they need to replace inadequate systems and solve emerging problems in the 21st century, this invention addresses a glaring need unmet by previous systems.

An exemplary embodiment of the RebelBase Innovation Learning System is discussed in further detail below.

### 1. RebelBase System Representation

RebelBase is a learning, collaboration, and networking platform for:
Innovators and entrepreneurs, including students learning to apply the entrepreneurial process to a range of problems
Educators and managers that aim to develop skills through project-based learning
Communities that support and fund innovation and innovation learning, and stakeholders in those communities
   It is designed to serve as a platform for innovators to launch projects by navigating step-by-step modules that elicit feedback, support the iteration of published responses to the project Builders, and generate project profiles.

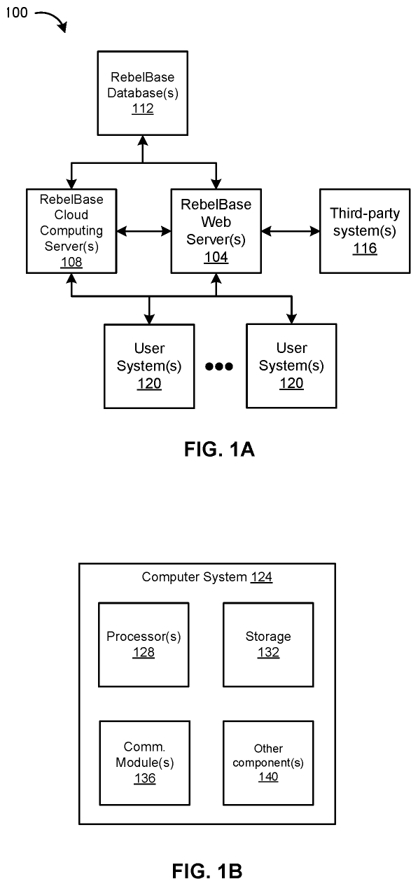

FIG. 1A depicts an embodiment of an architecture of the RebelBase Innovation Learning System (ILS) 100. The system 20 may include one or more web servers 104, one or more cloud computing servers 108, one or more databases 112, more or more third party systems 116, and a plurality of user systems 120. The one or more servers web 104 serve interfaces, such as web pages, to the user systems, containing the functionality of the ILS 100 being provided to the users, and receive back from the user systems input to the interfaces, as discussed herein. The one or more cloud computing servers 108 may cooperate with the one or more web servers 104 to provide components of this functionality to the one or more web servers 104 and/or directly to the user systems, as it may be advantageous to split the computing load to generate the interfaces between servers and cloud computing devices to thereby together provide the functionality of the ILS 100. Similarly, the one or more third party systems 116 may provide components of the functionality to the one or more web servers 104, as it may be advantageous to utilize certain third party systems that specialize in certain functionality. The one or more databases store data of the ILS 100, such as user and project profiles, builders, etc., as discussed herein, for access, modification and/or storage by the one or more servers 104 and cloud computing devices 108 to implement the functionality of the ILS 100 discussed herein. The user systems 120 are computing systems utilized by any of the users of the ILS, such as Rebels, Judges, Administrators, etc., to engage the functionality of the ILS 100 as discussed herein.

In embodiments, an ILS may include only any subset of, or an alternative connection or ordering of, the features depicted in or discussed herein in regard to FIG. 1A.

Embodiments of the web server 104, cloud computing server 108, database 112, third party system 116, and/or user system 120 and/or any individual one or subset of these, and/or any individual one, subset, or all of the components of thereof, may be implemented as hardware, software, or a mixture of hardware and software. For example, each of the web server 104, cloud computing server 108, database 112, third party system 116, and/or user system 120, and/or any individual one, subset, or all of the components thereof, may be implemented using a processor and a non-transitory storage medium, where the non-transitory machine-readable storage medium includes program instructions that when executed by the processor perform embodiments of the functions of such components discussed herein. In exemplary embodiments, each of the web server 104, cloud computing server 108, database 112, third party system 116, and/or user system 120, and/or any individual one, subset, or all of the components thereof, may be implemented using one or more computer systems, such as, e.g., a mobile computing device, a desktop computer, laptop computer, network device, server, Internet server, cloud server, etc.

FIG. 1B depicts an embodiment of a computer system 124 that may be used to implement any of the web server 104, cloud computing server 108, database 112, third party system 116, and/or user system 120, and/or any individual one, subset, or all of the components thereof. The computer system 124 includes a processor 128, a non-transitory machine-readable storage medium 132, a communication circuit 136, and optionally other components 140. The processor 128 executes program instructions stored in the non-transitory machine-readable storage medium 132 to perform the functionality of the system or component that the computer system 124 is implementing, as discussed herein. The communication circuit 136 can be controlled by the processor 128 to communicate with other devices, such as any other of the web server 104, cloud computing server 108, database 112, third party system 116, and/or user system 120, to perform the functionality of the system or component that the computer system 124 is implementing, as discussed herein. The other components 140 may include any further components required by the computer system 124 to perform this functionality, such as, for example, a display, input device, etc., in the case of the user systems 120.

In embodiments, a computer system that may be used to implement any of the web server 104, cloud computing server 108, database 112, third party system 116, and/or user system 120, and/or any individual one, subset, or all of the components thereof, may include only any subset of, or an alternative connection or ordering of, the features depicted in or discussed herein in regard to FIG. 1B.

In the ILS 100:
a) Multiple users can access the RebelBase website provided by the web server 104 via a web browser of the user systems 120, concurrently and simultaneously.
b) The RebelBase website sends user requests to the RebelBase system of servers 104, 108 and databases 112 which process the requests and take necessary actions.
c) Third-party systems 116 can be integrated with the RebelBase system for various purposes such as analytics, storage, etc.

### 1.1. The Stack

The RebelBase platform is built on a common, field-tested tech stack.

This platform will need to support simultaneous connections among hundreds of thousands of users, which is supported by its current stack.

The RebelBase stack includes:
Front End
Back End/API
Database
Hosting
Security
Analytics
Privacy

RebelBase's processes include version control, task management, and backlog grooming; and feature development, and issue resolution. These processes and tools are subject to change at any given time. The testing process occurs on the staging server.

### 1.2. Architecture

### 1.2.1. Application Layers

The API layer, the Business Logic layer, and the Database layer are three modular layers of the back end application. These layers are decoupled to support multiple types of devices (desktop, mobile, tablet, etc.) and operating systems (Android, iOS, etc.) and to provide flexibility in the architecture. This enables the development team to change or swap out any component, at any time, for any reason (newer tech, better tech, easier tech, etc.).

### 1.2.2. Application Program Interface (API)

The RebelBase API is universal and supports all client types. The web-based application was the first to launch; mobile support is currently offered via device browsers. The platform-agnostic architecture of our API means that it will seamlessly support dedicated web, tablet, mobile browser, and future versions of RebelBase as mobile and desktop applications, whether they are developed in native mobile languages or with cross-platform frameworks.

### 1.2.3. Front End

The RebelBase front end is a single-page application, which makes the user's experience fast and seamless. Currently, RebelBase is a browser-based application that uses API requests and sockets to communicate with the back end. This is subject to change at any point in the future to support further development.

### 1.2.4. Back End

The back end is built for scalability and natively supports socket connections to create real-time applications. This makes it ideal for RebelBase features which are designed to function without page refreshing, such as profile updates, live messaging, and Hub activities.

### 1.2.4. Business Logic & Database

The back end's business logic layer holds all of the operations that process data on RebelBase. This layer communicates to the database layer, which interacts with the database servers. By decoupling the business logic and database layers, we can easily change database engines or implement multiple databases at the same time.

### 1.2.5. Hosting

The RebelBase application is hosted on cloud servers. Currently, we have one production server which runs the application. All RebelBase user data is stored on a secure and isolated database server. Media files are stored on a web interface service like Amazon S3 Bucket server. The modular architecture allows the spin-up of additional servers as bandwidth demands rise, without fragmenting users. A separate build server compiles the RebelBase application before deployment.

### 1.2.6. Integrations

RebelBase works with various integrations. These include:
Error-tracking software that helps developers see errors in real-time
Web analytics software for tracking and reporting website traffic
A data analytics platform for monitoring servers, databases, and tools
Analytics software for tracking user data

Additional integrations will be added.

### 1.2.7. Security

By using DNS service, RebelBase is protected from denial of service and other malicious server attacks. All traffic on RebelBase is routed through HTTPS to encrypt user sessions using SSL. While all user data is securely stored in isolated servers, further steps to protect sensitive user data, such as passwords and tokens are done using encryption. Additional security measures will be implemented in the future.

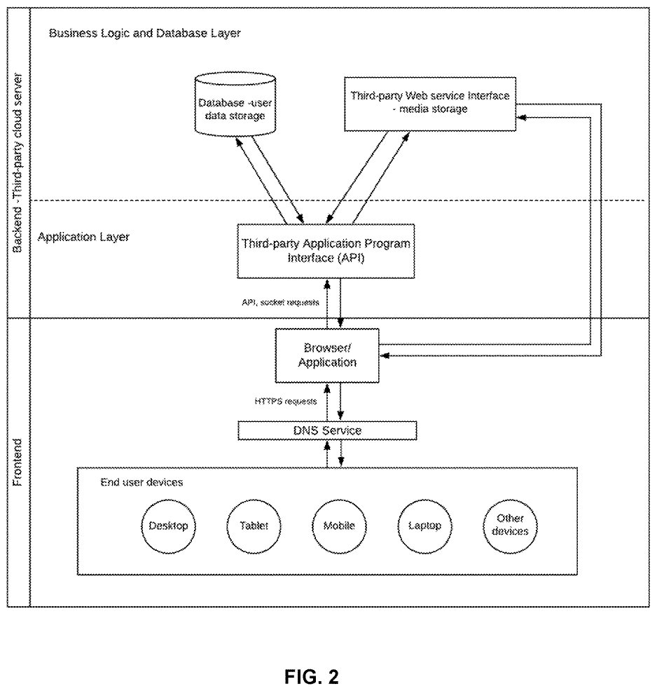

FIG. 2 depicts an embodiment of the division of the architecture of the RebelBase ILS 100 between a frontend and a backend.

As shown in FIG. 2:
The front end consists of end-user devices and the browser. The end-user devices such as tablets, mobile, desktop, etc. communicate with the browser using HTTPS requests, through a secure DNS service. Multiple users can access the browser simultaneously and concurrently.
The front end browser communicates with the back end using API requests and socket requests.
The back end comprises the Application Program Interface (API), database, and web service interface. The entire back end is hosted on a third-party cloud server.
To read and write user data, the browser sends a request to the API, which forwards the request to the database. Based on the authorization of the user, the database either accepts or rejects the request. If the request is accepted, the requested information is sent back to the browser/end-user.
The end-user can view the stored media files such as images, video, audio, etc. from the web service interface via the browser. The browser directly sends a request to the web service interface, to request access to view the user's media files. After authenticating the request, the web service interface allows access to view the requested files.
To edit a stored media file, a request is sent to the back end API via the browser, which then redirects the request to the web service interface. After authenticating the request, the web service interface responds by making the necessary changes to the file.

Following is a sample communication for project creation for a successful use case:
1. Project Form
   On the front end, the user populates an HTML form which will be used to generate the payload (data containing the parameters) in a JSON format for the project.
2. Form Submit
   The user submits the form by clicking a button. Basic validation is done on the frontend such as checking if mandatory fields are filled.
3. API Request
   The payload is generated and a POST request is made to the server.
4. Server Receives Request
   The server receives the request and validates the request. Business logic (such as if the project name already exists and if it does it shows an error message) is applied to the request.
5. Database Entry
   SQL Query is generated and data is entered into the database.
6. API Response
   The server returns a response with the data that was created.
7. Project Render
   The project is created and displayed to the user.

Following is a sample communication for successfully logging in and updating a Builder:
1. The user enters login information. POST Request is sent to the server.
2. Server receives the request, and applies business logic (ensuring username and password is correct). Returns a success response.
3. User selects the project. A GET request is made to get the project data.
4. Server receives the request and ensures the user has permissions for the project.
5. Database is queried and project data is returned to the user.
6. Builder Form
   On the front end, the user populates an HTML form which will be used to generate the payload (data containing the parameters) in a JSON format for the Builder.
7. Form Submit
   The user submits the form by clicking a button. Basic validation is done on the frontend such as checking if mandatory fields are filled.
8. API Request
   The payload is generated and a PUT request is made to the server.
9. Server Receives Request
   The server receives the request and validates the request. Business logic (such as ensuring the user is part of the project and has permission to update the Builder) is applied to the request.
10. Database Entry
   SQL Query is generated and data is updated in the database.
11.API Response

The server returns a response with the data that was updated.

In general communications on the platform follows similar steps where business logic and validation changes for the use cases.

### 2. How it Works

Once the user signs up to RebelBase there are two main parts: Projects, and Hub.

### 2.1. Projects

What is a project? A project represents a user's (and their team's) incremental development of their solution.

User interaction: Upon joining RebelBase, the user has access to Projects. Under Projects, the user can create a project. The user can invite others to join their project. This project can later be added to an Event, Hub, and/or a Group.

### 2.2. Hub

What is a Hub? Each community that subscribes to RebelBase gains use of a “Hub,” with functionality such as discussion forums, networking support, cohort management, and Event management tools. This functionality helps instructors generate peer learning and Administrators manage innovation ecosystems.

User interaction: Upon accepting an invite to a Hub, the user becomes a part of the Hub. The Hub includes the following: Activity, Brain, Builders, Groups, Hub Events, and Members. The user can participate in Events under Hub Events and join a Group upon invitation from the Hub admins.

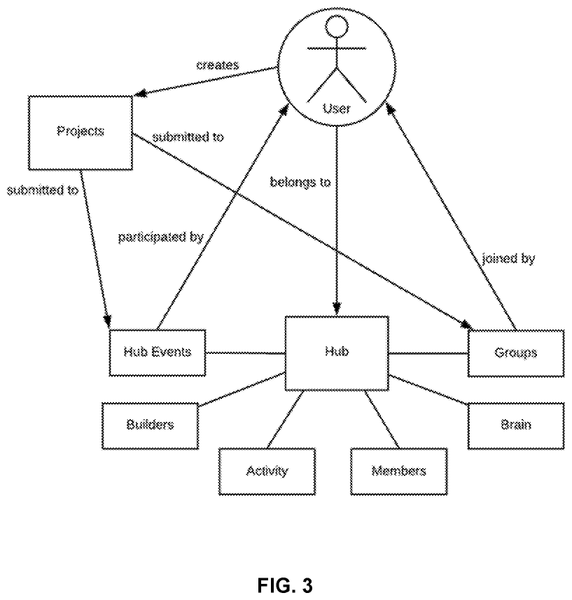

FIG. 3 depicts an embodiment of a network showing connections and relationships between users, projects and hubs.

Upon joining an Event under Hub Events, users can submit their projects to the Event page. Similarly, upon joining a Group, each user's latest project will be submitted to the Group and the user can change the project any time. In both cases, the project profile will be linked to the page, allowing other Event participants or Group members to view the project.

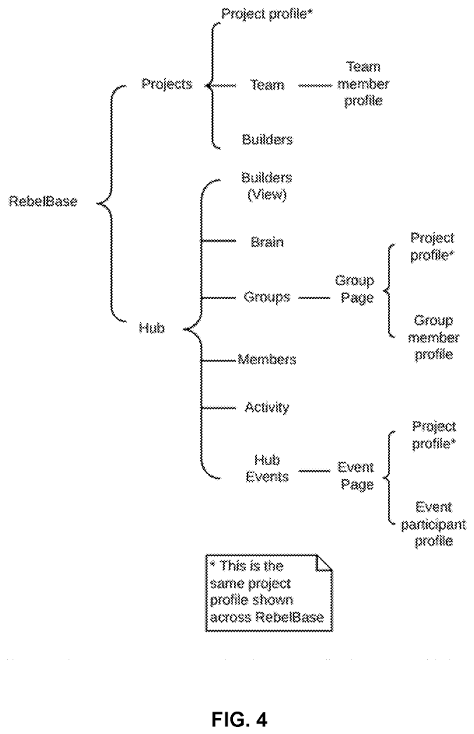

FIG. 4 depicts an embodiment of a map of the connections between Projects and Hubs in the ILS 100.

### 2.3 User Interaction With RebelBase Platform

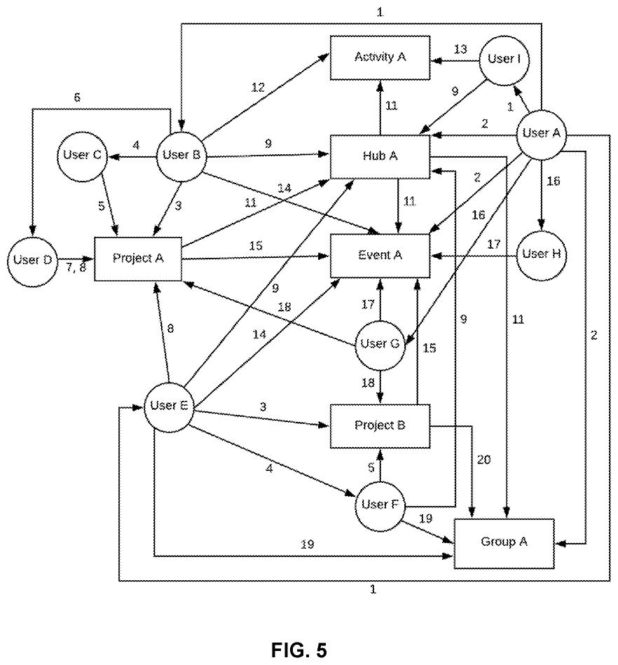

FIG. 5 depicts an embodiment of the connection between various users and their actions on Projects, Hub, and Events in the ILS 100. The depicted numbered actions include (listed by number below):
1. User A invites User B and User D as competitors; User A invites User I as a member.
2. User A creates Hub A and Event A and Group A.
3. User B creates Project A; User E creates Project B.
4. User B invites User C to join as a teammate to collaborate on Project A; User E invites User F to join Project B.
5. User C joins Project A as a teammate; User F joins Project B as a teammate.
6. User B invites User D to join the project as a Supporter.
7. User D accepts the invite.
8. User D and User E leave a comment on Project A.
9. User E, User B, User F, and User I join Hub A as Hub members.
10.Project A is submitted to Hub A.
11.Event A, Hub A, Activity A, and Group A are part of Hub A.
12.User B asks a question in Activity A.
13.User I answers the question in Activity A.
14.User B and User E participate in Event A.
15.User B submits Project A to Event A; User E submits Project B to Event A.
16.User A invites User G as a Judge in Event A; User A invites User H as a sponsor.
17.User G joins Event A; User H joins Event A.
18.User G judges Project A and Project B.
19.User A invites User E and User F to join Group A.
20.User E and User F submit Project B in Group A.

### 3. User Journeys

### 3.1. Hub Administrator's Journey

In a first aspect, a client gets a Hub subscription to RebelBase.

Suppose, for example, that the client is a university instructor who is teaching multiple courses on entrepreneurship. The instructor asks her department to subscribe to a Hub so she can use the platform to run her courses. Upon purchasing the Hub subscription, the client receives permission vía an email to be the Hub's lead Administrator. (Depending on the subscription tier the department orders, the Hub may serve a single instructor, a department, an entire university, or a network of universities. In this illustration, for simplicity's sake we assume the instructor is the Administrator).

In a second aspect, the lead Administrator then invites co-Administrators into their Hub space.

As the Hub's lead Administrator, the instructor starts by inviting additional Hub Administrators (such as departmental Administrators, faculty colleagues, teaching assistants (TAs), pitch competition organizers, etc.) to join the Hub. These additional Administrators can manage the Hub along with the lead Administrator.

In a third aspect, Administrators next invite Rebels, Supporters, and General Members to the Hub.

Hub Administrators invite additional members to join the Hub. Administrators may invite members to take three types of roles: ‘Rebels,’ ‘Supporters,’ and ‘General Members.’ Rebels are those who lead and participate in projects. Supporters are those with expertise and resources they're willing to share with Rebels. General members are those without a defined role, such as alumni who want to pop in and see the Hub, and may become Supporters later. Invitations are sent through the RebelBase platform to invitees' email inboxes.

In a fourth aspect, those invited accept their invitations and populate the Hub.

When a user accepts the invitation, that user is taken to the platform and prompted to enter her information to create an account and a Profile Page. In the Profile Page, the user can give a brief introduction about him- or herself, add a profile picture, and describe relevant professional experience. After doing so, the user has access to the Hub space.

In addition to entering the basic information required to create an account and profile page, individuals have the option to create a member card. Member cards are the ‘game cards’ that appear when someone enters the ‘Members’ page in the Hub space. They show the user's photo, name, affiliation, and ‘powers,’ that is, skills or areas of expertise. The system nudges Supporters to designate their powers, so Rebels can find and reach out to those with the skills and expertise the Rebel needs. These skills and areas of expertise make it easier for the Hub community to interact. For example, if a Rebel needs a brand strategist, he or she can browse the Members Page for members whose cards boast skills that pertain to that need, and the system can facilitate relevant matches.

In a fifth aspect, once people are in the Hub, Administrators set up their Hub's Groups.

Groups enable for facilitators and instructors to make RebelBase their own, choosing builders relevant to a given class, incubator, or competition, viewing builders to decide which are relevant, choosing from templates where useful, setting milestones for those builders, monitoring teams' progress, and communicating with their cohort. Essentially, Groups enable the Hub to be divided and organized into multiple cohorts. To set up a Group, an Administrator names it and adds people to it from a list of all Hub members. For example, if a university professor is organizing a Group, the professor will, for each class he or she is running, create a Group, name the Group by the class's title, and add the Rebels enrolled in the class into that Group.

The Administrator can have as many Active Groups as the subscription tier allows. If the Administrator needs to make another Group, but is maxed out, he or she can deactivate or delete one of the active groups to make room for a new group. A deactivated will retain all of its information, but it will be unusable while it is inactive, until it is activated again. A deleted Group will disappear, along with all of its information.

In a sixth aspect, Administrators set a schedule for each Group.

After creating a Group, the Administrator sets a schedule for the Group. The schedule consists of the Builders covered by the program, arranged in a logical sequence according to the theme of the program. Builders are learning modules that guide innovators (hereafter referred to as ‘Rebels’) as they build their project profiles. They cover a variety of lessons that help Rebels challenge their assumptions, develop their thinking around their project, and add to its emerging profile.

The Administrator sets the schedule most appropriate for each Group's (or program's) learning objectives. They can either choose a templated schedule or build a schedule from scratch. The templates have a set of Builders pre-selected and ordered according to useful course topics and formats. If an Administrator chooses a templated schedule, she can use it as-is or she can use it as a baseline and then edit it to customize it for her needs. If, after exploring the templates, the Administrator determines that none of the templates quite fit her needs, she can build a schedule from scratch.

To build a schedule from scratch, the Administrator browses the Builders and makes strategic decisions about which to include, depending on her goals and curriculum. The Administrator selects the Builders she wants in the schedule, then arranges them in the order in which he or she wants the Group to work on them. If she desires, she can also set due dates for the Builders she assigns to the Group.

In a seventh aspect, Administrators host an onboarding session with Group participants.

After they have set up Groups and selected Builders, Administrators host an onboarding session where Rebels learn to navigate the platform. This session can be virtual or physical. It introduces the RebelBase Method and the chief components of the platform. RebelBase provides facilitators and instructors with templates and materials for conducting this session and introducing key activities that follow.

### 3.2. Rebel's Journey

In a first aspect, Rebels ideate using their Hub's Activity Page.

After Rebels are invited to the Hub, create accounts and user profiles, and have been onboarded by an Administrator, many programs begin with an ideation process. After Rebels are introduced to the ideation process, they spend some time brainstorming problems and possible solutions. Then, each Rebel posts one of his or her ideas along with details about that idea to the Hub Activity Page, where other members of the Hub will be able to see it. Once all users have posted their initial ideas, their peers are asked to post responses (either brainstorms, questions, or offers to help) to the posted ideas.

In a second aspect, Rebels create or join Projects.

After the ideation process has given Rebels a chance to explore ideas for projects they would like to work on during the remainder of the class, accelerator program, or other sequence, Rebels can choose to pursue the idea they have posted and create a project or decide not to create their own project and instead join a classmate's project.

Rebels who want to create a project click ‘Create a Project.’ Questions appear on-screen to assist them in readily setting up a project profile. Leaders of projects can then invite fellow Rebels to join their project as team members.

Rebels must be affiliated with a project to gain access to the Builders.

In a third aspect, Rebels begin their first Builder reading assignment.

Rebels participating in a class follow the schedule of Builder assignments created in their class's group. Rebels begin their first assigned Builder by clicking into the Builder. This transfers them to a page that lists several topics, called the Overview Page. Rebels click to enter each Topic in the Overview Page to read the learning content. Each Topic begins with a question posed to the student and ends in a blank answer box for the student to fill in a response. When completing the assignments, the student will read the Briefs and Inspiration Bytes to learn key concepts and frameworks, and they will also complete the Workshops and RebelMaps to research and think through their answers to the Topic's question. Sometimes, the Rebels will complete the Workshops and RebelMap and input their answers directly into the answer box. Other times they will come up with provisional answers and share these on the Activity Page to get feedback before they write answers into the answer box.

In a fourth aspect, Rebels post provisional answers on the Activity Page to elicit feedback.

If a Rebel wants to test a provisional answer, he will go to the Activity Page and select ‘idea,’ which allows him to write down his team's preliminary answer and post it to the Activity Page. Other Rebels in the ecosystem respond to this post with ‘brainstorms,’ ‘questions,’ or ‘offers.’ Supporters can also join the conversation and voice their feedback to the team. The team, represented by the student who posted the idea, can join the conversation or note takeaways.

In a fifth aspect, Rebels use the feedback from the Activity Page to refine their answers.

After exchanges take place on the Activity Page, each team draws on the input given by the Rebels, Supporters, and Administrators in response to their post to tweak and refine their answers.

The cycle of putting something out there, eliciting feedback, and then going back to the drawing board (and repeating that cycle over again) helps the Rebels become familiar with and open to the process of iteration. While doing so, Rebels learn to harness the creativity and diversity that comes from a Hub's ecosystem. The feedback helps teams take ideas in directions they hadn't thought of or spot holes in their logic they hadn't seen.

In a sixth aspect, Rebels save their refined answers to the Topic's Answer Box.

When teams have refined their answers to the point that they feel their answers are ready to be saved, they type it into the answer box provided at the end of each Topic and click ‘Save.’ Once the team enters and saves their answers to each Topic in the Builder, they move on to the Review+Publish Page.

In a seventh aspect, Rebels use the Review+Publish Page to publish their work on the Builder to their Project Profile page.

On the Review and Publish Page, Rebels can see, in one place, all their answers to each Topic question they saved throughout the Builder. The way the answers appear on the Review+Publish Page is how they will appear on the team's Project Profile Page should they click ‘Publish.’

Teams give their answers a final review and select a privacy setting before publishing. The privacy setting indicates who will be able to see their answers after they are published. Rebels can select ‘My Events’ to make their answers viewable only to the people who are also part of their Events, they can select ‘My Hubs, Groups, Events’ to show the project to fellow Hub members along other members in their Groups and Events, or they can select ‘Public’ to make their answers viewable to the general public. If the Builder isn't ready for the public eye or the answer includes sensitive information, the Rebels can choose ‘Team’ to publish their answers only to their internal team. Rebels make their choice as a team and click ‘Publish.’

Once published, the answers will automatically populate to the team's Project Profile under a section titled the same name as the Builder.

If they aren't ready to publish it to everyone, but they want a specific advisor or mentor to see it, they can invite that individual to their project as a Supporter. That means that the Supporter will be able to view all saved answers but not be able to edit.

In an eighth aspect, Rebels review each other's project profiles and add notes to continue the project refinement process.

Each section in a Project Profile has space for fellow Rebels, Supporters, and Administrators to add notes. For example, after a team has finished and published the ‘Core Belief’ Topic under the ‘Brand’ Builder, anyone with a link to the team's Project Profile can give notes on how well the team completed the topic.

To prompt another round of feedback, the program facilitator asks Rebels to give live notes on a team's project profile as the team presents. In other words, if a team is presenting their work on the Brand Builder, the rest of the cohort may be asked to open the presenting team's Project Profile and add any comments, questions, and recommendations they have as notes to the Brand section of the Project Profile. This method maximizes the amount of feedback a presenting team obtains, and it ensures that the feedback is captured in a record.

In a ninth aspect, Rebels interact with one another on the Activity Page.

The program facilitator can generate discussion and collaboration on the Activity Page throughout the program by giving Rebels a due date by which to post their thoughts around a particular topic on the Activity Page. The facilitator can also require Group members to respond to others' ideas and questions around a coordinated time-frame. This level of management can be a powerful method for fueling online brainstorming and ideation throughout a term.

In a tenth aspect, Administrators also interact with Rebels on the Activity Page.

All Hub Administrators can monitor the feed and provide feedback of their own. Feedback from facilitators can motivate Rebels and show them that their work is being reviewed.

In an eleventh aspect, Rebels continue to work through the Builders according to the schedule to collaboratively build out their project profile.

Teams go again through the iterative process outlined for the first Builder assignment for each of the following Builders assigned to their Group according to the schedule set by the facilitator. To recap this process, teams read the Builder content, then use the Activity Page to elicit feedback on their preliminary answers, then use the feedback generated to refine their answers, then publish their answers to their Project Profile Page, then present their work to the class, during which the presenting team receives more notes and feedback on their Project Profile Page.

As a team completes Builders and publishes answers, their Project Profile Page becomes robust and informative, showcasing information one would typically find in a business plan.

### 3.3. Event Administrator's Journey

In a first aspect, Administrators can create Events for their classes, competitions, or challenges.

Participants can be invited as ‘Competitors’ (anyone participating as part of a project team), ‘Judges’ (anyone reviewing projects), ‘Sponsors’ (if you have people or organizations donating resources), Support (if you have invitees willing to advise and support your competitors), and ‘General’ (if they have no specified role).

In a second aspect, Administrators organize Events through the platform for members of the Hub to attend.

Administrators organize and host Events for their Hub to participate in. These Events can be set up as educational exercises or as opportunities for Hub members to earn real prizes. All Events involve the Hub's teams showcasing their projects.

In a third aspect, the Event Administrator uses the RebelBase platform to create a new Event.

By clicking ‘Hub Events’ the facilitator is taken to a page where he or she can see all of the Hub's Events and also create new ones.

For example, say an Event Administrator has decided to host a pitch-off competition for university students at the end of their semester. In a pitch-off competition, different teams vie to convince Judges that their project is the strongest. This type of Event is a typical way to culminate an innovation course because it gives student teams a chance to pitch their projects under competitive pressure, for evaluation by outside Judges.

To create the Event, the Administrator clicks ‘New Event’ and is prompted to enter the name of the Event, the date and time of day it will be held, and the type of Event, which in this case, is a ‘Competition.’

While entering the basic information about the Event, the Administrator is prompted to decide whether or not the Event will have Judges. The Administrator determines that the Event will have Judges and is prompted to enter how many rounds of judging there will be. The Administrator can choose between one to five rounds.

As a last step, the Administrator enters a brief description of the Event and clicks ‘Next.’ By doing so, he or she is redirected to the Event Page for their Event, which is now all set up.

In a fourth aspect, the Administrator invites competitors to the Event.

Once on the Event page, the Administrator adds new participants by clicking the ‘Invite” button in the ‘Participants’ box. Before sending out the invitations, the Administrator chooses the type of participant he or she would like to send invitations to, then enters the email addresses of anyone who will occupy that role. In this case, the Administrator selects ‘Competitor’ then enters the email addresses of all of their Rebels.

The Administrator decides that, in addition to inviting all of the Rebels in his or her Hub, he or she will also include Rebels who are taking an entrepreneurship course powered by RebelBase at a different school. Inviting participants from outside of one's Hub is supported by the platform's functionality.

In a fifth aspect, Supporters receive invitations to the Event.

Using the same process, the Administrator can also invite Supporters to the Event. These participants will be listed as ‘Supporters’ and typically volunteer to help competitors in the Event.

In a sixth aspect, sponsors receive invitations to the Event.

Sponsors are people who donate resources to the Event. In return for donating their resources, the sponsors' logos are listed on the Event Page in acknowledgement of their support and as a way to increase their brand awareness.

In a seventh aspect, Judges receive invitations to the Event.

Competition rounds are typically judged by experts affiliated with the Event's Hub.

The Event Administrator sends invitations to Judges for the Event. When a Judge receives an invitation, she clicks on the link and is taken to the RebelBase platform, where she is prompted to make an account and enter a short bio and upload a profile picture. Once complete, the Judge appears listed on the Event as a Judge.

In an eighth aspect, Event participants can communicate through posts on the Event Page.

Information and questions about the Event can be shared in both the Event Description and through posts on the Event Page itself.

### 3.4. Judge's Journey

In a first aspect, projects are assigned to the Judges.

When an Event begins, the Event Administrator assigns Judges to evaluate each project in the Event. When this happens, the Judge is responsible for reviewing the Project Profile pages of the teams they were assigned. Over the course of the semester, the teams have saved their answers to the assigned Builders to create informative and rich Project Profile pages. The Judge accesses these Project Profiles through the Event Page.

Often, the Judge will listen to pitches from the teams they've been assigned. While they listen, they can also explore the project's written profile on screen and develop a nuanced understanding of the project.

In a second aspect, the first round of the Event begins.

Before the first round of pitching begins, the Administrator uses the platform's functionality to open the round for scoring. This gives Judges access to a common rubric that is embedded in the platform. All Judges use the same rubric to evaluate the contestants.

As the round commences, teams pitch to their assigned Judges. Their goal is to have the most convincing and investment-worthy project as determined by their panel of Judges. While listening to a team pitch, Judges scroll through the team's Project Profile. They use the rubric to rate the team's performance in different areas, referencing common criteria.

After the round is over, Judges either discuss results with one another or make their final decisions on the scores and click ‘submit’ to save the scores. The platform automatically tallies and ranks the competitors for that round.

In a third aspect, the pitch-off competition continues until the final round.

The same process ensues for each subsequent round of the pitch-off competition. Judges listen to student-led pitches, Project Profiles bolster the pitches, scores are given, and results are tallied. Typically, pitch-off competitions follow the procedure for a bracket tournament. This means that the winning teams from each round compete against one another until only two semi-finalists remain. Then, the semi-finalists face off in the final round.

Scores are submitted and tallied for the final round, and winners are announced. The Administrator can choose to give awards on the platform for first, second, and third place.

In a fourth aspect, sponsors contribute prizes, Judges award prizes.

For sponsored events, sponsors may have provided cash or in-kind prizes for winners. If this is the case, after the Judges have determined who the competition's winner or winners are, sponsors award their prizes.

Prizes, such as seed money and consultations with experts, help the winning team, should they decide to continue to develop their project and work to launch it as a startup.

In a fifth aspect, teams debrief after the competition.

It requires a unique skill set and a depth of emotional resilience to keep forging forth down a path that has yet to be charted, yet this is what entrepreneurship asks of those who pursue it. The RebelBase platform seeks to teach the necessary hard and soft skills critical for entrepreneurs to master.

The pitch-off competition is one way that this learning takes place. For example, as teams develop and practice delivering their pitches, they refine skills critical to being an entrepreneur but also to succeeding in the 21st century workplace at large. Such skills include communication, public speaking, and collaboration.

After the competition, Rebels debrief on how the competition challenged them to ideate, find proof of concept, build a solution backed by market research and package it into a pitch convincing enough to deliver to a panel of experts with a prize on the line. They walk away from the competition with more confidence that being an entrepreneur or innovator is an obtainable career option.

### 3.5. Supporter's Journey

In a first aspect, Supporters receive an invitation to RebelBase.

Supporters can include a hub Administrator's professional contacts, program alumni, or any other affiliates of a Hub that take an interest in continuing to participate in the Hub's efforts to educate and innovate. When Supporters receive invitations to RebelBase, they will be asked to create User Profiles and will then fill out their Member Cards, including their skills (Powers) and contact information.

In a second aspect, Supporters engage in the Activity Page.

One simple way for Supporters to give to the community is to engage in the Hub's Activity Page. They can reply to Rebel's ideas and questions on this page, or they can post useful resources and make offers to help.

When they engage in this way, Supporters can be very valuable resources in a Hub's ecosystem. They bring knowledge and other resources that can help Rebels develop their projects in powerful ways. And the best way to spark this engagement is when Hub Administrators take steps to invite their engagement through concrete requests.

In a third aspect, Supporters join projects and events.

Supporters can also contribute by joining projects and events. When they join projects, they can give teams focused advice on how to improve their projects. When they join events, they can make themselves available to give feedback to any of the event's competitors that might reach out.

The best way to engage Supporters in this way is for Rebels and event Administrators to take the initiative to reach out to Supporters and tell them how they can contribute.

### 4. Project Creation

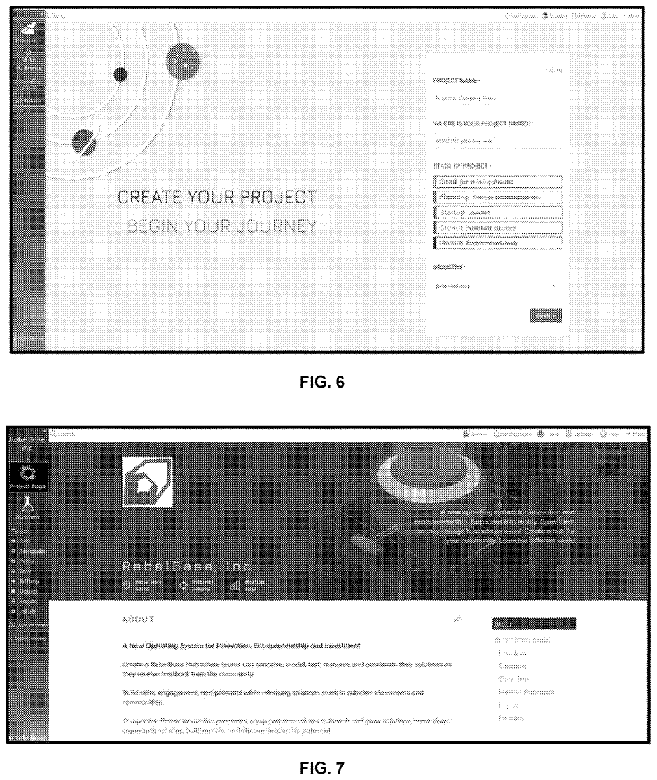

FIG. 6 depicts an embodiment of the Project Creation page of the ILS 100.

Project Creation is the first step in developing a project. The user will establish the location where the project is set to be launched, the target industry, and the stage of the project. Project names are unique. If the project name is already in use, the user is prompted to provide a different name for the project. Once the project is assigned a name, click create to create a new project.

On clicking “Create Project,” the user is redirected to the Builder page with a pop-up box to choose the Builder track and a notification with a hyperlink to choose teammates. The user can click the ‘close’ icon to close the pop-up and notification.

### 4.1. Project Profile

The Project Profile gives an overview of the entire project.

FIG. 7 depicts an embodiment of a snapshot of the Project Profile page of the ILS 100.

### 4.1.1. Top Bar

The top bar has the following options. This bar is available on all pages:
a. Search—Clicking on the search button opens a page with all available projects on RebelBase. Type the name of the project in the search bar or scroll down to find the project. Use the filter on the right to filter projects based on the industry. Select a project to view its Project Profile.
b. Notifications—It lists changes in projects, Events, or Hubs along with invitations.
c. Username—Click the username to visit the user profile page.
d. Settings—Click settings to visit the settings page.
e. Help—Click help to visit the help page.
f. More—Click more drop-down button and click logout.

### 4.1.2. Middle Pane

The middle pane displays the project name, industry, location, and the project stage. The below list describes the editable functionalities available in the middle pane.
a. Logo—Users can add an image as the project logo. Click the “change logo” button to trigger a pop-up box where the user can upload an image file from their local drive. Click the ‘save logo to Project Profile’ button to save the logo. If successful, the user is notified that the project logo was uploaded.
b. Backdrop—Users can add a backdrop image to their Project Profile. Hover over the upper, colored section of the Project Profile to find the upload backdrop edit icon. On clicking the icon, a pop up appears which allows the user to upload an image file from their local drive. Click ‘save backdrop to product page’ to save the image. If successful, a pop-up text box notifies the user on the action performed.
c. Description—Hover over the upper, colored section of the product page to see the edit description icon. On clicking it, the user can enter a brief description of the project. The maximum character limit is 250. Click ‘save’ to save the description. To cancel the description, click ‘cancel’. A pop-up box appears to ensure if the user wants to proceed with the cancellation. Click ‘No, go back’ to avoid the cancellation, else click ‘yes, cancel.’ A pop-up text box notifies the user of the action performed.
d. About—The About section allows the user to give an introduction with text, photos, and/or videos. Click the edit icon. The user has options to change the size, style, format, alignment, and indent of the text. Click twice on the icon to unclick the icon. Click the video icon to embed a video link. Click ‘save’ to save the video or click outside to cancel the video. Click the picture icon to insert a picture from the local drive. Click ‘save’ to save the file else, click ‘cancel’. Once done, click ‘save’ to save the changes or click ‘close’ to delete the changes. A pop-up appears to confirm with the user to discard the changes. Click ‘yes, close’ to discard the changes, else click ‘No, go back’.
e. Team—The team section displays the team members of the project with their name, title, and profile picture. Project creators/owners can edit the title for all team members. Other users can only edit their own titles. Click the edit icon on the top right of the team section to open account settings. Click the project you want to change the title. In the input box under the person's email, you can type their title and hit save. Explore “How do I add a title to my teammates and myself?” on the help page to learn more.
f. Published section—This section lists the published content from each Builder-track. Navigate the Builder modules sequentially to publish solutions on the Project Profile. The project creator can choose who can view the published contents using the drop-down list on the right.
g. Kudos—For each published solution anyone using the platform, except the project owner, can give Kudos for appreciation. A counter keeps track of the number of Kudos received. Click What is a Kudos? from the help page to learn more about Kudos.
h. Notes—Notes in each published solution is open for anyone on the platform to give suggestions or comments. Click ‘Note’ and type the note in the text box and click a note to save it. If the user clicks ‘Note’ when no text has been entered, a notification appears to instruct the user to enter a note. A counter keeps track of the number of Notes received. Use the drop-down icon to view all Notes.

### 4.1.3. Right Pane

Click on the headings in the right pane to jump to a section on the Project Profile without scrolling.

### 4.1.4. Left Side Menu

The left side menu helps navigate to other sections relevant to the project. To hide this menu, click the close icon on the upper right corner of this menu. This menu is available on every page.
a. Project name—Click the drop-down icon below the project name to switch to other projects or click ‘New Project’ to create a new project.
b. Project Profile—The Project Profile of the project chosen in the above section is displayed.
c. Builders—Click Builders to view all the Builders available for the current project listed by groups or tracks.
d. Team—Click ‘Add to team’ to add team members. A detailed explanation can be viewed in section 5.3. of this document.
e. Home menu—Displays the home menu options.

### 5. Builders

The RebelBase methodology separates the process of entrepreneurship into its component pieces. Each component piece (such as problem identification, human-centered solution design, building a team, competitive analysis, impact analysis or financials) is introduced to the user in an approachable way using a curation of learning content. Collectively, this content is called a Builder.

When a user enters a Builder, they will find that the subject matter is divided into Topics, like subheadings under the main title. A Builder will have anywhere between two to five Topics. Each Topic begins with a question posed to the user and the remainder of the Topic provides the user with enough support that they can thoroughly answer the question by the end of the Topic. As they progress through the Topics, they continually build-out their projects. This support is delivered through definitions of terms and concepts (called briefs), inspirational stories (called inspiration bytes), practical application tools (called workshops), and visual diagrams (called RebelMaps) that instruct users to apply what they've learned to their entrepreneurial pursuits.

When users reach the end of a Topic, they are prompted to answer the question which was posed at the beginning of the Topic. Often, this means reporting insights that were gleaned or research that was conducted during the interactive workshop component of the Topic. The answer can be saved, edited, and revised until the user feels confident and ready to publish it. Publishing an answer enables the content to be seen in the “Project Profile” and based on the privacy settings others users can see the “Project Profile” which reads like an online business plan for the user's venture. In sum, the Builders give the curriculum its concrete expression and accompany entrepreneurs on their journey to mastery.

### 5.1. Builder Tracks

The RebelBase platform offers tracks such as Ideation, Validation, Launch, Scalability, Impact, and Results. Once a track is chosen, the user is redirected to the Builders. By choosing a track, a user indicates to the platform where in the conception, launch or growth of a venture the user is, and in turn, the user is shown Builders that are especially helpful and relevant for that stage.

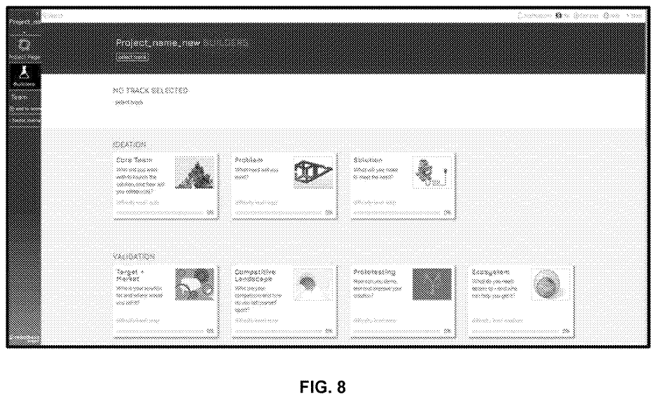

The user would be redirected to set off related Builders if they chose to pursue the designated track. The words “On Track” would be followed by the name of the track chosen, such as “Ideation.” FIG. 8 depicts an embodiment of a Builders home screen as it would appear for user. In FIG. 8, the Builders that belong to the Ideation track are displayed in a row. The user can adhere to the track by completing the Builders within it in order from left to right. Users can switch tracks at any point of time, as choosing a track does not lock the user into anything. By scrolling down, the user can still see and explore the entirety of the rest of the Builders.

If a user is part of a Group in a Hub and the Group has a schedule, in addition to the track options, they will see their Group. If they select that Group, they see the Builders the Group manager set for them with due dates.

The top banner shows the project name, current track in progress. On the upper right corner, a progress display shows the user progress of the recently modified track. The ‘Jump back in’ section displays the last three modified Builders. The next section displays the track the user last modified with its Builders. After this section, all the tracks with their Builders are displayed. The user can scroll down to select a Builder.

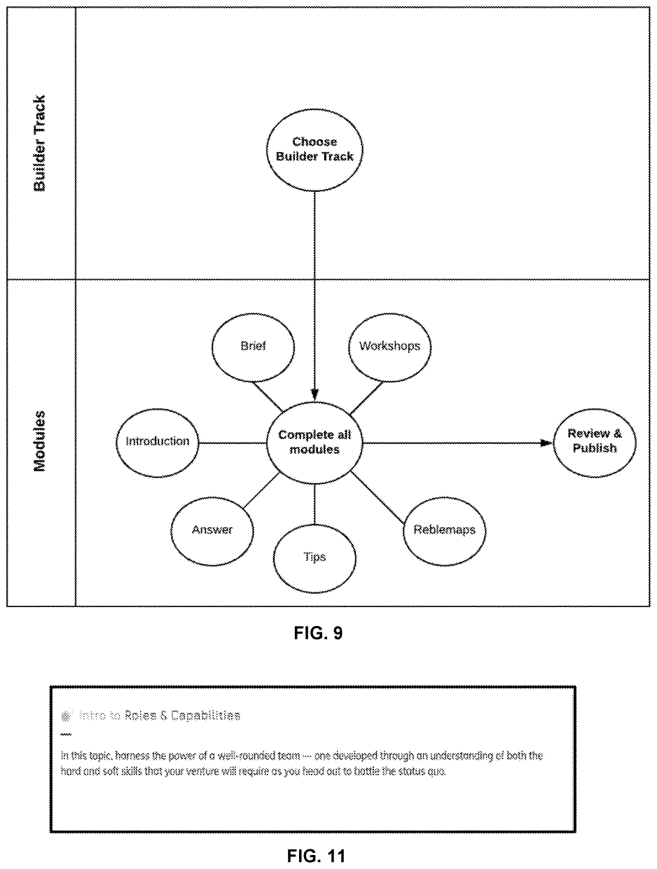

FIG. 9 depicts an embodiment of a network describing user builder track and modules.

### 5.2. Builder Components

### 5.2.1. Overview Page

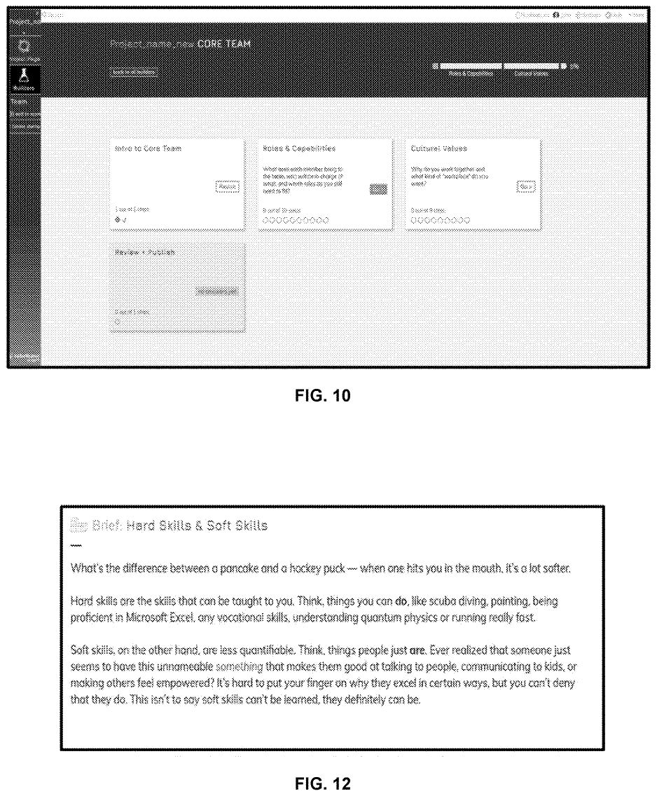

Once the user clicks to enter a Builder, they land on the Builder's Overview Page. FIG. 10 depicts an embodiment of the Builder Overview page as it would appear for user. A series of panels displays the component sections of the Builder. The first section is always an introduction to the Builder, then there is one section for each Topic within the Builder, and then a final section called “Review+Publish.” The first time a user visits a Builder, each section's panel on the Overview Page will have a button in the bottom right corner that says “Go.” The user clicks this button to enter and read the section's content. After the user visits all the sections and/or answers the Topic question, the “Go” button will change to say “Revisit,” letting the user know that they've visited this section before. The user can track their progress within the section by looking at the circles at the bottom of the section's panel. The circles turn blue as the user enters into a section and views each piece of content within it. A progress bar at the top of the Overview Page allows the user to track their progress through the entire Builder by percentage of completion. The functions of the review and publish section will be described in section 5.2.2.8.

### 5.2.2. Topic Components

### 5.2.2.1. Intro to Topic

FIG. 11 depicts an embodiment of an example Intro to Topic as it would appear for user.

This is the first step in a Topic. It serves as a brief overview of the Topic about to be explored and outlines the workshops the user will complete.

### 5.2.2.2. Briefs

FIG. 12 depicts an embodiment of an example Brief displayed for user.

Briefs are approachably written definitions to terms and concepts a user without a business background might find unfamiliar.

### 5.2.2.3. Inspiration Bytes

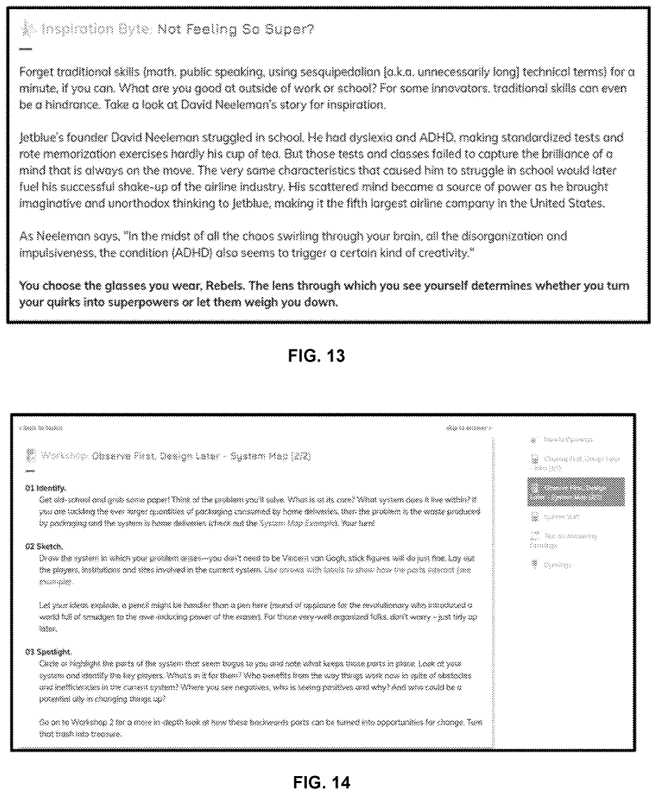

FIG. 13 depicts an embodiment of an example Inspiration Byte displayed for user.

Inspiration Bytes are examples, stories, or insightful tidbits that give color and context to the terms, concepts and goals of the Topic. Inspiration Bytes often acknowledge the psychological obstacles entrepreneurs come up against and provide relief by offering encouragement grounded in science and relatable stories.

### 5.2.2.4. Workshops

FIG. 14 depicts an embodiment of an example Workshop instruction page.

Workshops give students actionable steps they can take to purposefully think through or research answers to the questions.

### 5.2.2.5. RevelMaps

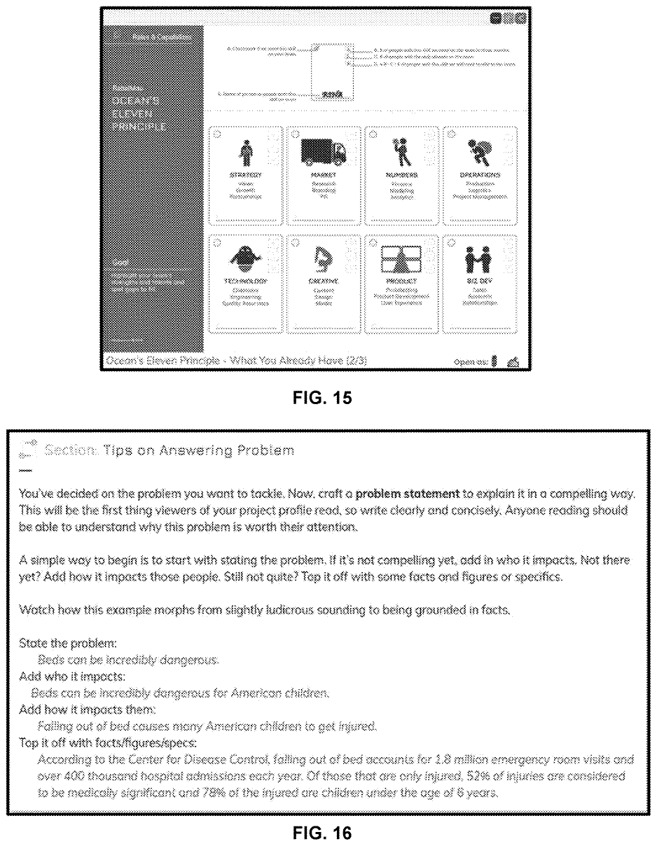

FIG. 15 depicts an embodiment of an example RebelMap displayed for user.

Provides accompanying worksheets that contain useful visual aids and exercises to help students complete the Workshops. RebelMaps appear on the bottom right corner when a user is working through a Workshop. The user has the option to minimize, enlarge, or move the map. At the bottom of the map, they can click the editing icon, which will open the RebelMap as an interactive file that the user and their team can work on collaboratively.

### 5.2.2.6. Tips on Answering

FIG. 16 depicts an embodiment of an example Tip displayed for user.

Tips suggest to the user a way that they can thoroughly and thoughtfully answer the question posed at the beginning of the workshop.

### 5.2.2.7. Answer Box

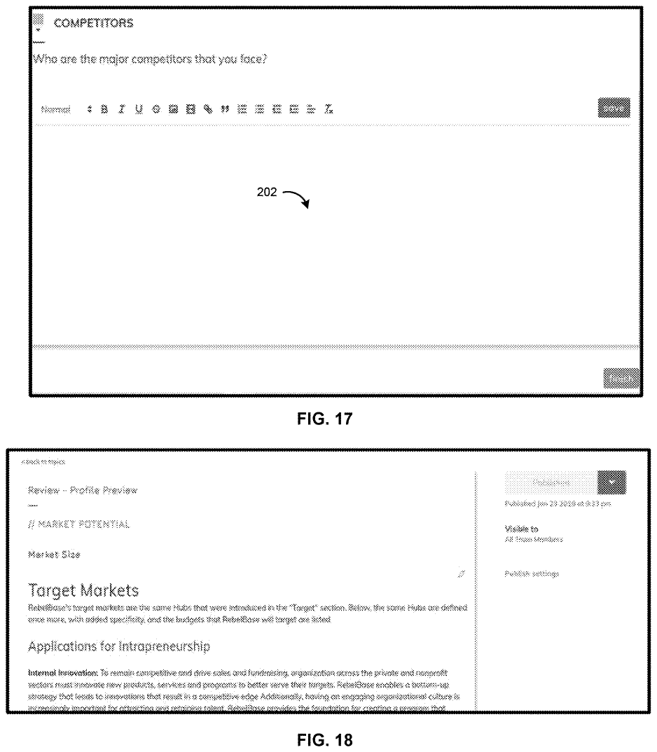

FIG. 17 depicts an embodiment of an example Answer Box displayed for user.

As the last step within a Topic, indicated by a small pencil icon, is a space 202, i.e., an interface field, for users to input their answer to the question posed at the beginning of the workshop and repeated here. A textbox with different style formats, alignment, indent, and size is present where users can also add images and embed videos. After answering the question, users can click “save” to save the response and then “finish” to complete the Topic. Clicking finish will automatically redirect the user to the Builder's Overview Page. If a user is revisiting the Builder, they will see “Go to Review+Publish>” on the top right corner of the box to easily change the settings which is explained in the next section. When the user revisits the Builder, or if another user with access to the Builder such as a team member visits the Builder, the user or other user will see the already entered answer populated into the field 202, and can edit the already entered content, such as to change the answer, provide additional elements of the answer, etc. For example, in the exemplary embodiment of FIG. 17, if the original answer to the question of “Who are the major competitors that you face?” is “Big box stores,” a revisit or visit by another user may populate the answer field 202 with “Big box stores,” and then the revisiting user or other user may modify the content in the populated field 202, such as to read “Big box stores and traditional mom and pop stores.” In other embodiments, the revisit or visit by the other user may display any already entered answer in another location instead of populating it into the field 202.

### 5.2.2.8. Review+Publish

FIG. 18 depicts an embodiment of an example Review+Publish page displayed for user.

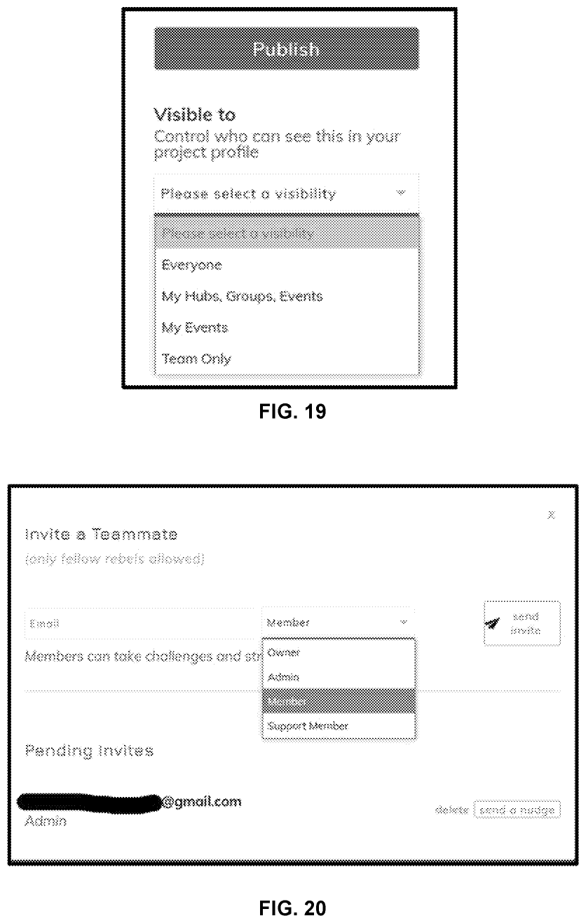

FIG. 19 depicts an embodiment of an example visibility settings displayed for user.

The last panel on the Builder Overview Page is for reviewing and publishing the work the user completed while in each Topic. Each Topic ended in an opportunity for the user to write and save an answer to a question. Here, the user can see all the answers that they saved, organized by Topic. The user can click the pencil icon to the left of their answers to edit each one by Topic. Once the user is satisfied with their answers, they can publish their work to the intended audience by changing the visibility settings on the far left. Click How do I control who sees my Project Profile? to learn about this on the help page.
The option ‘Everyone’ allows the public to view the published results on the user's profile page. The viewer does not need a RebelBase account to view the results.
The option ‘My Hubs, Groups, Events’ moderates the visibility to Hub members along with attendees of a user participating in the Event.
The option ‘My Events’ limits visibility to attendees of an Event.
The option ‘Team Only’ limits the visibility to team members and support members.
   These publishing options are examples and will be expanded to allow users to select which Hubs, Groups or Events.

Should the user click the large ‘Publish’ button in the top right corner, their answers will be automatically populated to their Project Profile, becoming one section of their Project Profile, which serves as an on-platform business plan.

### 5.3. Assign Teammates

Users can collaborate and form teams. Teammates are invited via email to join the project.

If the proposed teammate has a RebelBase account, an email to login and accept the invite is sent. If not, an email to sign up and accept the invite is sent. Once the invitation is accepted, the project can be viewed as per the role assigned to the new teammate. Invites sent via email are not time-bound; if a proposed teammate hasn't accepted the invite, the project creator can send a ‘nudge’ which is essentially a way to resend the invite. Invites can be deleted if needed.

FIG. 20 depicts an embodiment of an example prompt to invite teammates.

A role with a specific attribute is assigned to teammates by the project creator/owner. Team members with higher permission levels can change other team member's roles. The order of permission level is an owner, admin, and support member. Click ‘How do I change the role of myself or my teammate?’ in the help page to learn more.

### 5.3.1. Owner

The role ‘Owner’ is automatically assigned to the project creator. The project creator can assign the role to team members as well. Owners have unlimited access to the entire project. Once assigned, the role cannot be revoked. Only owners can delete the project.

### 5.3.2. Admin

All team members invited to the project are automatically set as admins. Admins can manage users and project settings.

### 5.3.3. Member

Team members assigned the role ‘Member’ can take challenges and strengthen the project. They can edit the Builders, choose who to publish to, edit the Project Profile, enter competitions, and add more members. Click ‘How do I add a teammate or an advisor?’ in the help page to learn more.

### 5.3.4. Supporter

Members assigned as ‘Supporter’ have limited access to project settings and can view the project's content before it is published. Supporters are advisors who will not be working on the project per se but will check the work and give feedback before anyone else does. If the user publishes to the team only, support members can see it. Click ‘How do I add a teammate or an advisor?’ in the help page to learn more.

Each team member plays a different role that affects how they interact with the Projects system. The diagram below displays the functionalities each type of team member can perform.

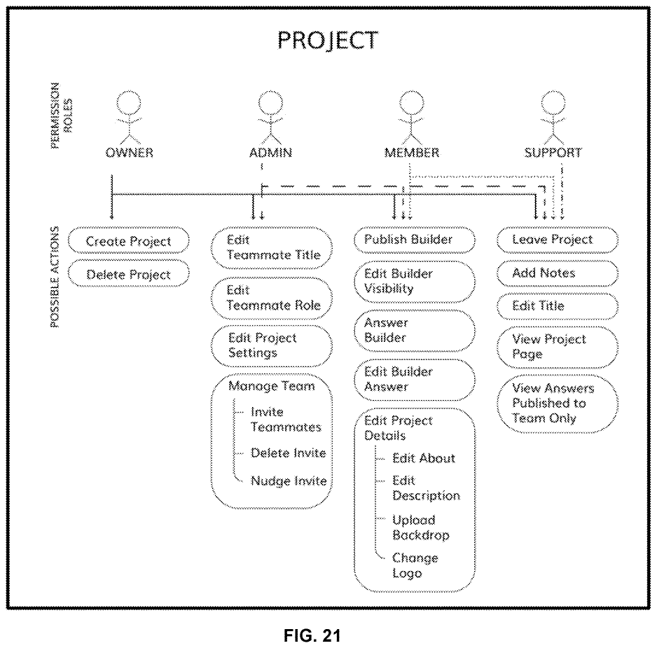

FIG. 21 is a chart depicting an embodiment of the functionalities each type of project team member can perform.

### 6. Builders and Feedback Loop/Network

### 6.1. Builders—Feedback

After publishing a module, users can view the completed work and give feedback by giving a Kudos or leaving a Note. This feedback serves as a way to help users iteratively improve their solutions. The screenshot below displays a view of a Builder after it has been published and the option to give feedback.

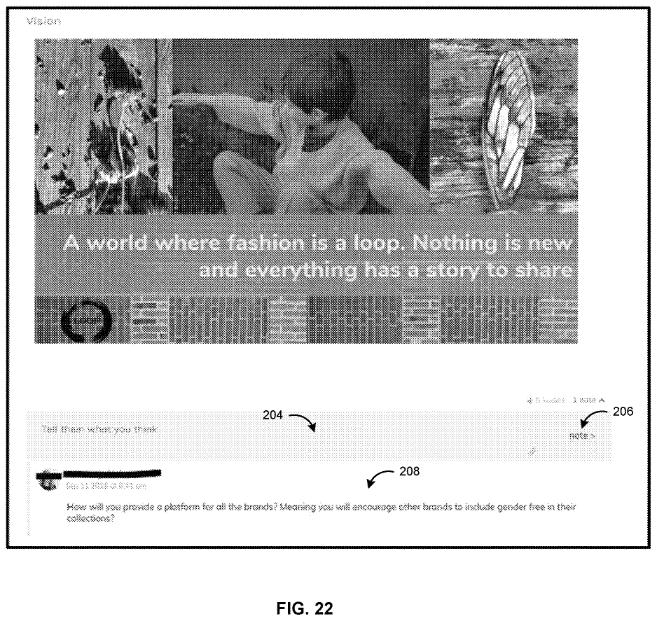

FIG. 22 depicts an embodiment of an example feedback on a published Builder. For example, the interface may provide is a space 204, e.g., an interface field, for users to input their feedback to the published module. The published module can include the answer to the question as entered and potentially refined by the user in the project having the builder module. In one embodiment, similar to providing the answer in FIG. 17, a textbox with different style formats, alignment, indent, and size can be present where users can also add images and embed videos, etc. After providing feedback, users can click on a button 206 (e.g., in the exemplary embodiment depicted in FIG. 22, the “note” button) to save the feedback, which can then be accessed by the owners and team members in the project. As feedback is accumulated on a published Builder, previously entered feedback 208 can also be displayed.

After a published Builder has received feedback, team members for the Project including the published Builder can view the feedback, and then go back and continue to modify the answer to the question in the Builder module based on the feedback, to thereby continue to iterate the Builder module including the answer. For example, team members can go back to the interface discussed with respect to the exemplary embodiment of FIG. 17 to continue to modify the answer to the question of the Builder module.

### 7. Person Profile

A screenshot of a person profile page is shown below. This is where users can share about themselves, their experience and skills.

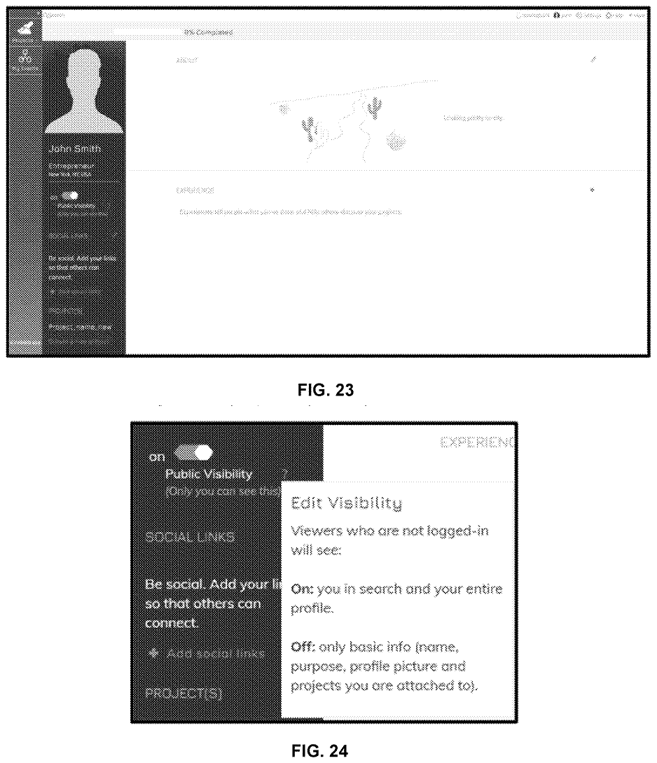

FIG. 23 depicts an embodiment of a Person Profile page.

### 7.1. About

The user can give a brief introduction about themselves. Once the required information is entered, click save. The user is notified that the changes were saved by a pop-up box.

### 7.2. Judge Bio for Events

If a user acts as the Judge for an Event, they can include a brief description about themselves—designation, background, etc. This is intended to help Event contestants know the Judge's competencies.

### 7.3. Experience

Experiences tell people what the user has done and helps the user to showcase their projects or work experience to the public. Click the + icon on the upper right corner to add a new experience. Under the ‘Add Experience’ section enter the start and end date. Select Present checkbox to declare the projects the user is currently working on. Enter the title, affiliated company or school name, project description, and click save. A pop-up box on the top of the screen confirms that the experience was saved. The experience is now visible to the public. Click the edit icon on the upper right corner of the added experience to edit it. In the edit experience box, the user can choose to save the changes or delete the experience.

### 7.4. Progress Bar

A progress bar shows the percentage of data entered on the profile page.

### 7.5. Profile Picture

Click upload profile and click select avatar. The user can choose an image from their local drive to add as a profile picture. Click save. Follow the same steps to replace the current profile picture.

### 7.6. Profile Data

Below the profile picture, the user name, user purpose, and location are displayed.

### 7.7. Public Visibility

The public visibility can be toggled on or off. Only the user can view the public visibility settings.
a. Visibility ON: Viewers who are not logged in can access the user's entire profile through search.
b. Visibility OFF: Viewers who are not logged-in will see only the user's basic info namely name, purpose, profile picture, and the user's projects.

FIG. 24: depicts an embodiment of a Person Profile visibility settings.

### 7.8. Social Links

Users can add their social links to connect with other users. Click the edit icon to connect with social links such as Linkedin, Facebook, and Twitter. Click save.

For testing, the account name and the full URL should be entered. In both cases, the system should be able to truncate if needed and direct to the correct URL.

### 7.9. Project(s)

A list of the user's projects is displayed. A ‘Create a new project’ link is present to create a new project.

### 8. Hub

RebelBase's Hubs enable entrepreneurs to draw from an ecosystem of peers and invite experts to refine their ideas. Hubs host communities dedicated to the common purpose of innovation, and they offer features specially designed to cater to this purpose. Hubs make it possible for entrepreneurs to draw on the wisdom of the crowd to strengthen their innovations—a technique that RebelBase's curriculum values highly.

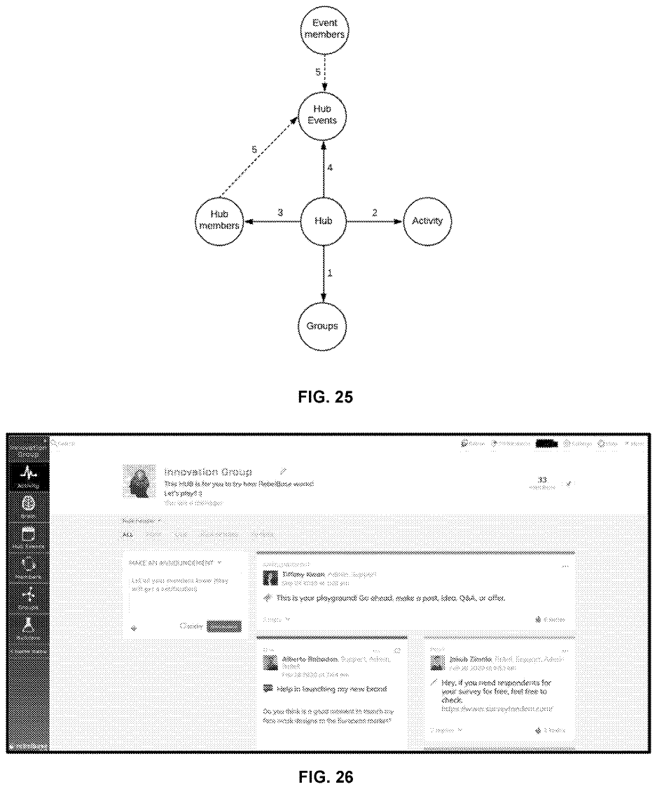

FIG. 25 depicts an embodiment of a flow chart representation of the Hub and its features. The main features are—Activity, Event, members, and Groups. Other features will be added in the future.
1. The Hub has a Group feature which is used to create groups, schedule Builders to each group, and enables group members to submit projects.
2. The Hub's ‘Activity’ feature is a digital forum for members to discuss ideas, share knowledge, and connect over projects.
3. Hub members feature displays all the key information about the members (skills, projects, roles, contact) available at-a-glance.
4. Hub's, Events and their built-in rubrics make it easy to organize competitions, manage classes, and host meetups.
5. Hub members and Event members can participate in Events. There are various Event types: challenge, meetup, selection, competition, etc.

### 8.1. Hub Banner

Hub Banner has the info section which allows the admin to insert a brief description of the Hub page.

FIG. 26 depicts an embodiment of the Hub Banner as it would appear for Hub Admin user.

Click the edit pencil icon to change the logo and description of the Hub. Click select logo to insert a new logo image from the local drive. Edit description text box. Click save to save the changes. Click the close icon to exit without saving. Click How do I change my Hub logo and description? In the help section to learn more. Below the description, ‘You are a manager’ displays the current user's role in the Hub. The below screenshot shows the ‘change Hub details’ dialog box.

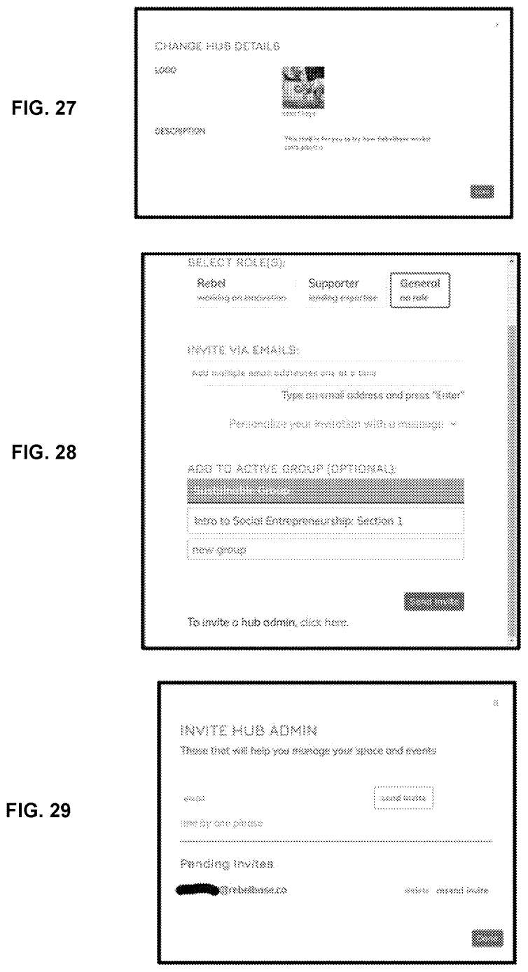

FIG. 27 depicts an embodiment of the dialog box to change Hub details.

### 8.2. Inviting Users to RebelBase, Hubs, and Events

### 8.2.1. Invite to RebelBase

Any time someone is invited to any of RebelBase's digital spaces (Projects, Hubs, Events, etc.) those who have not yet made an account will be prompted to do so. In other words, to get someone onto the platform, invite them to one of these spaces. Invitations are sent via email.

### 8.2.2. Invite to a Hub

As a Hub Administrator, the left-hand sidebar will show buttons that lead to several different pages (Activity, Brain, etc.), and each of these pages has a section in the top right corner that leads to a list of members. Click on the checkmark or link on these pages to open a window that will allow the Administrator to invite members. More details can be found in section 8.3.

### 8.2.3. Invite to an Event

On RebelBase Event pages, there is a list of participants in a box on the upper right-hand side of the page. Click the “Invite” button on that box to invite participants.
Participants can be invited as
   Competitors—anyone participating as part of a project team
   Judges—anyone reviewing projects
   Sponsors—people or organizations donating resources
   Resources—invitees willing to advise and support competitors
   General—no specified role

More details can be found in section 10.1.

### 8.3. Hub Member Roles

In the top right corner, the count of Hub members is displayed. Click the tick icon to either edit the current user's role or to invite members to the Hub.

### 8.3.1. Invite Members to the Hub

FIG. 28 depicts an embodiment of the Hub Member invitation box. The admin can select the role of the new user and invite them via email. The new user can be added to any active Group (Groups are explained in details in section 11.). Refer ‘What are the Hub member roles?’ in the help page to learn more about Hub members.

### 8.3.1.1 Select Role(s)

a. Admin

In every Hub, there must be at least one admin account. The admin manages the Events, Members, and Activity. If a user signed up for the subscription, then that user is the admin for the Hub. Users can also become an admin if another admin assigns it. Use the ‘Click Here’ link at the bottom of the invitation box, to invite a user as Hub admin.

FIG. 29 depicts an embodiment of the Hub Admin invitation box.

To invite a Hub admin, send them the invite via email. If the user does not have a RebelBase account, they will receive a ‘signup and accept invite’ email. If the user has a RebelBase account, they will receive an email to accept the invite along with a notification in their RebelBase account. In the help page, refer to ‘How do I invite other Hub admins?’

The list of pending invites is displayed at the bottom. Options to delete the invite or resend the invite are present. Once the necessary changes are completed, click done. To exit, click the close icon on the top right corner.

b. General

This is a default card for any member without a role. This card is temporary and will change into another card once a role is assigned.

c. Rebel

Innovators are termed Rebels. Rebels are any Hub members working on a project (including “founder” types, teammates, and advisors). They can submit themselves as part of one project or multiple projects associated with the Hub.

d. Support

This role is occupied by those people who are not directly on a team but are ready and eager to offer their help, guidance, or support to Hub members. Supporters are the experts, mentors, and door openers who take Rebels and their innovations farther than they could make it on their own. These members can add their “powers” to their card, to clarify exactly what kind of support they can provide.

e. Judge

A member must earn this card by becoming and completing a Judge role at one of the Hub's Events. This card shows the history of the Events the Judge has taken part in.

### 8.3.1.2 Invite Via Emails Option

Add an email address in the text box. Press enter to add multiple email addresses. The user can personalize the invitation with a message. Type in the message in the ‘Add your message’ text box.

### 8.3.1.3. Add to Active Group (Optional)

The member can be added to the active Group. Click ‘new group’, add a name, and click ‘create group’ again, to create a new Group.

### 8.3.2. Edit Roles

To edit the admin's role, click edit my roles from the tick icon on the upper right corner. Edit membership dialog box appears. Add or remove roles by clicking on the toggles that appear.

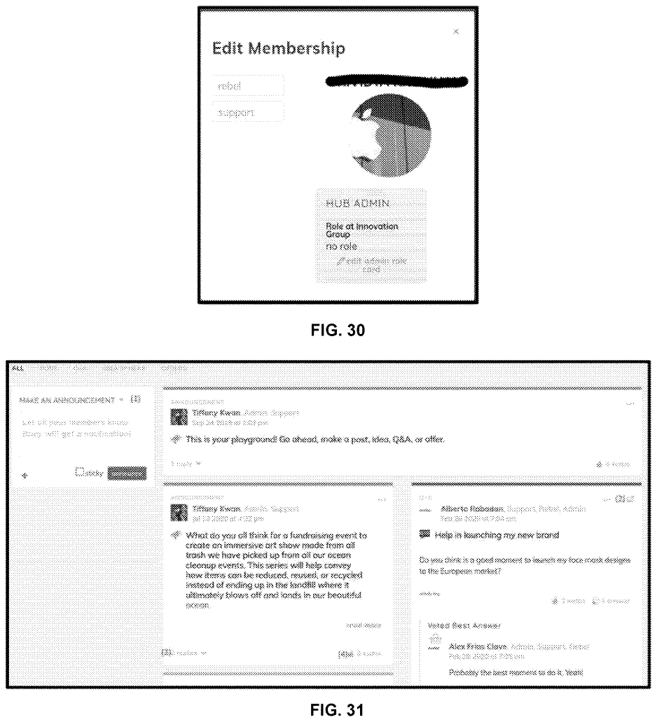

FIG. 30 depicts an embodiment of a dialog box to edit Hub Member roles.

To change the Hub members' roles and permissions, go to the “Members” tab on the left side of the Hub menu. On the page that appears, all members are listed. Click “edit membership” below the member. The admin can add or remove roles and permissions by clicking on the toggles that appear. Refer ‘How do I change my Hub members' roles and permissions?’ to learn more.

Once done, click the close icon on the upper right corner to close the invitation box.

### 9. Hub Activity

Activity is a space for members to interact. Here, Hub members and admins can type what they choose to and send it out to the group. Hub members and admins can use different types of communication, including announcements, posts, questions, ideas, and offers.

FIG. 31 depicts an embodiment of a snapshot of the Activity page.

FIG. 32 depicts an embodiment of a unified modeling language (UML) diagram for Hub Activity. The diagram shows the different functionalities admin and Hub members can perform under the Activity Page.

This page allows members to ask questions, promote ideas, gain feedback, and offer talent. Below is an explanation of the functionalities available in the Activity Page.

### 9.1. Posting

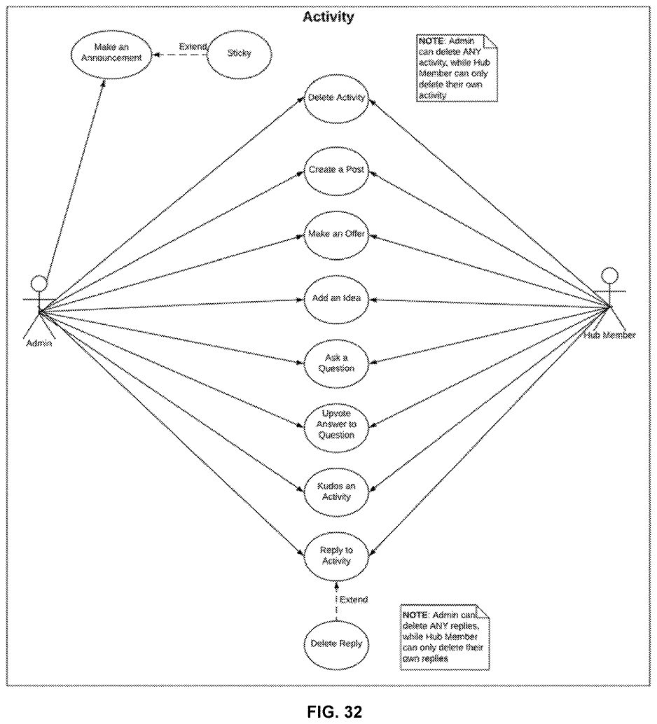

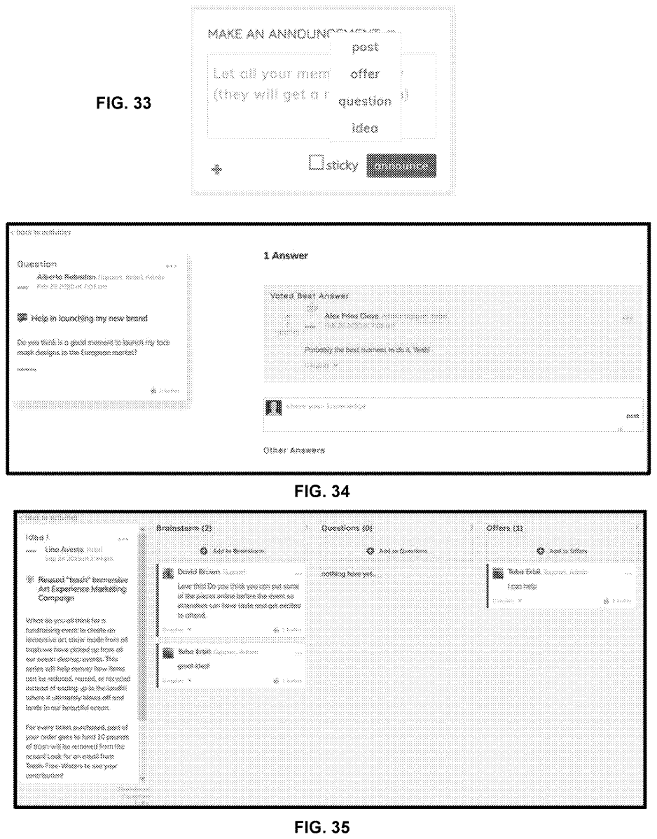

Clicking on the text box in FIG. 31 and as shown again in FIG. 33 (see below) gives the member the ability to start a discussion forum they want to share with the Hub.
a. Types of Forums—To switch between the different types, use the dropdown button on the header of the post and select the type you want to make. The types of posts include:
   i. Posts are for general interactions and messages.
   ii. Announcements are reserved for admins only and used to notify the whole community of something specific. For example, use it to announce an Event kick-off or to remind cohorts to submit by a certain deadline. Admins can choose to make their announcement sticky and it will stick to the top of the activities board.
   iii. Offers are used when members want to tell others that they have a resource to offer the entire Hub. For example, Albie from the finance department could add an offer to take a look at the project's financial models who would like to work with him.
   iv. Q+A's (Question and Answers) allow members to ask their burning questions and for helpful members to share their knowledge in return. Members have three days to upvote the best answer, after which the crowd-favorite is chosen and gets bumped to the top. But beware, the best answer spot can still be overthrown if another answer gets more upvotes later on.
   v. Ideas give members a way to gain feedback and validation on an idea they aren't quite sure about—which is pretty much every idea when starting something new. In this space, they can brainstorm to improve the idea, ask questions to clarify and poke holes, or offer a contribution to work with them on the idea.
b. Images—Members can add an image to a post by clicking on the ‘+’ button and clicking on ‘Image’. The following file extensions are allowed: .png, .jpeg, .gif, .tiff.

FIG. 33 depicts an embodiment of the different types of posts in Hub Activity page.

### 9.2. Expand Post

Clicking on the expand button displays the post in its own page. This is available for two types of posts: Q+A's and Ideas.
a. Q+A Expanded View—The Q+A expanded view allows members to answer questions, reply to answers, and upvote answers. Upvoting answers serve as a way for members to vote on the best answer to the question. The answer with the most upvotes will be displayed at the top as the ‘Voted Best Answer’.
b. Idea Expanded View—The Idea expanded encourages members to give feedback to others' ideas by brainstorming creative new directions, asking challenging questions, or laying out what they can contribute to help make the idea real.

FIG. 34 depicts an embodiment of an expanded view of a Q+A post.

FIG. 35 depicts an embodiment of an expanded view of an Idea post

Reply—Hub members can reply to a post by hovering over the reply count and clicking on it. This is available for Posts and Offers. Alternatively, members can reply to posts in the expanded view.

Delete Reply—Hub members can delete a reply by hovering over the three-dot menu and clicking delete.

Kudos—For each post and reply, members can give Kudos for appreciation. A counter keeps track of the number of Kudos received. Click What is a Kudos? from the help page to learn more about Kudos.

### 10. Hub Events

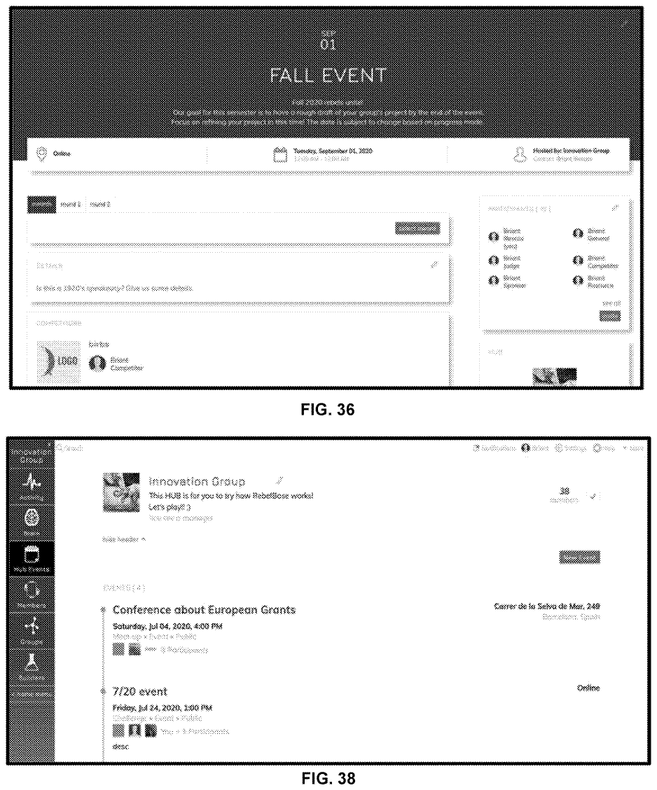

RebelBase Events are human-centric—they're the crossroads where different Rebels from across the board can connect, participate, and have a place to shine. Competitors, Judges, coaches, resources, and sponsors work together to bring an Event to life by uploading and editing their own information right on the Event page. FIG. 36 is a screenshot of an Event page.

### 10.1. Hub Event Members

Each member plays a different role that affects how they interact with the Hub Events system.

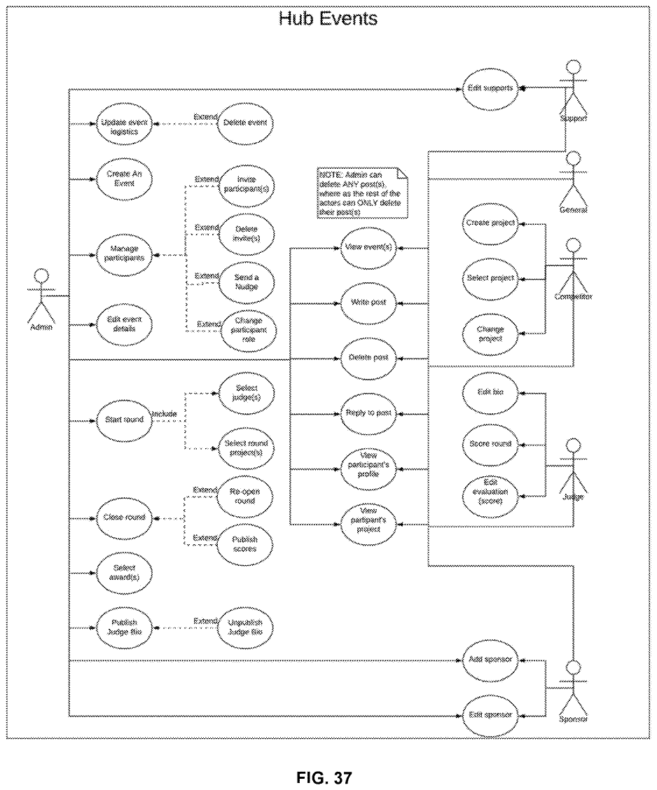

FIG. 37 depicts an embodiment of a UML diagram for Hub Events. FIG. 37 displays the different functionalities each type of member can perform.

There are members with different roles as part of the Event. Below is a list of member roles and their description.
1. Admin—In every Hub, there must be at least one admin account. The admin manages the Events, members, and Activity. If you're the one who signed up for the subscription, then you're an admin for your Hub. You can also become an admin if another admin makes you one.
2. Judge—A member must earn this card by becoming and completing a Judge role at one of the Hub's Events. This card shows the history of the Events the Judge has taken part in.
3. General—This is a default card for any member without a role. This card is temporary and will change into another card once a role is assigned.
4. Competitor (Rebel)—Competitors are any Hub members working on a project (including “founder” types, teammates, and advisors). They can submit themselves as part of one project or multiple projects associated with the Hub.
5. Sponsor—A sponsor brings Event donations such as space, catering, expertise, or prizes.
6. Support—This role is occupied by those people who are not directly on a team but are ready and eager to offer their help, guidance, or support to a team. Supporters are the experts, mentors, and door openers who take Rebels and their innovations farther than they could make it on their own. These members can add their “powers” to their card, to clarify exactly what kind of support they can provide.

### 10.2. Hub Events Page Overview

The Hub Events page is a tool used to create new Events and view existing/past Events.

The Hub Events page gives an overview of all existing/past Events. The image below is a screenshot of the Hub Events page.

FIG. 38 depicts an embodiment of the Hub Events page as it would appear for Hub Admin user.

### 10.2.1. Middle Pane

The top of the middle pane displays existing Events (if any) and Event logistics. These Events are sorted by their dates in ascending order. The bottom of the middle pane displays past Events (if any) and Event logistics. These Events are sorted by their dates in descending order. Below is a list of functionalities with the user type (actor) that are available in this section.
1. New Event (Admin)—Hub admins can create new Events by clicking on the blue ‘New Event’ button on the upper right of the middle pane.
2. View Event (ALL)—Users can view an Event page by hovering over an Event name and clicking on it. Upon clicking the Event name, the user is directed to the Event page.
3. View Participant Profile (ALL)—Users can view an Event participant's profile by hovering over their profile picture and clicking on it. Upon clicking on the profile picture, the user is directed to the participant's profile page.

### 10.2.2. Event Information

The list below describes the information shown by each Event tile.

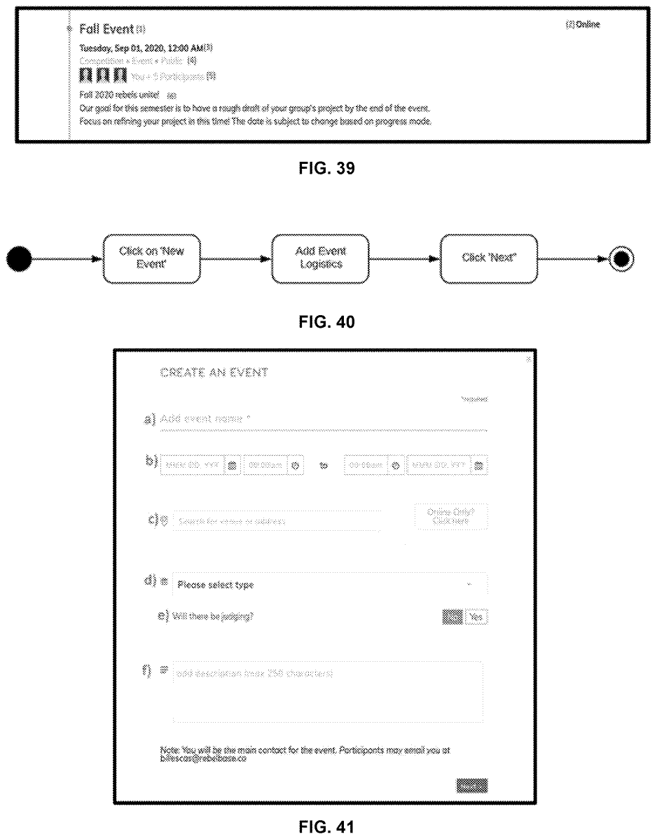

FIG. 39 depicts an embodiment of the event tile shown on the Hub Events page.
1. Event Name
2. Event Location
3. Event Start Date Time
4. Event Type
5. Event Participants
6. Event Description

### 10.2.3. Hub Event Creation Overview

FIG. 40 depicts an embodiment of the process to create a new Event, with the following preconditions:
1. User is logged in
2. User belongs to a Hub
3. User is an admin
4. User is on the Hub Events page

The list below describes this process in creating a new Event.
1. Click on ‘New Event’—Hub admins can create a new Event by clicking on the blue ‘New Event’ button. Upon clicking ‘New Event’, the admin is shown the popup on the screenshot below.

FIG. 41 depicts an embodiment of a dialog box to create a new event.
2. Add Event Logistics

Admins are prompted by the popup to fill in Event logistics. The list below describes the logistics an admin can add to an Event.
a. Event Name (required, editable)
b. Event Start/End Date (required, editable)—Admins have the option to designate if the Event will span several days or take place on one day, between certain times.
c. Event Location (required, editable)—The popup allows the admin to include an Event location. If the Event takes place in a physical location, the admin can enter and search for an address. If the Event takes place virtually, the admin can click on the ‘Online Only? Click here’ box.
d. Event Type (required, editable)
   i. Competition: an Event where innovators compete for prizes, awards, or recognition such as a pitch Event or business plan competition
   ii. Selection: an Event where the host is putting innovators through a selection process such as to get into an accelerator or get chosen for a competition.
   iii. Meet-up: an Event where people gather to exchange ideas such as networking party, fireside chats, and conferences
   iv. Assessment: an Event that happens at the end of a class, boot camp, or cohort where the innovators are assessed
   v. Challenge: a call to take part in a themed competition where innovators can submit their project for funding or partnership i.e., Ocean Conservation Challenge where all competitors need to have an ocean sustainability aspect
   vi. Other: Anything that doesn't fit into these categories
e. Event Judging (required, uneditable)—The admin is given the option to include judging in the Event. If the admin chooses ‘No’, there will be no judging included in the Event. Otherwise, if the admin chooses ‘Yes’, the admin is prompted to choose how many rounds of judging the Event will have.
   i. Rounds—Rounds serve as a way to split up an Event with judging. An Event with judging can be up to 5 rounds.
f. Event Description (optional, editable)—Admins are given the option to enter a brief Event description—with a limit of 250 characters.
3. Click ‘Next’

Upon clicking on ‘Next’, the admin is directed to the Event page of the Event just created.

### 10.3. Event Page Overview

An Event page is shown when the user clicks on an Event. This expanded view of an Event shows more information on the Event, including:
1. Event Logistics
2. Event Awards (if any)
3. Event Rounds (if any)
4. Event Details
5. Competitors
6. Judges
7. Sponsors
8. Supports
9. Posts
10.Participants
11.Hub Information

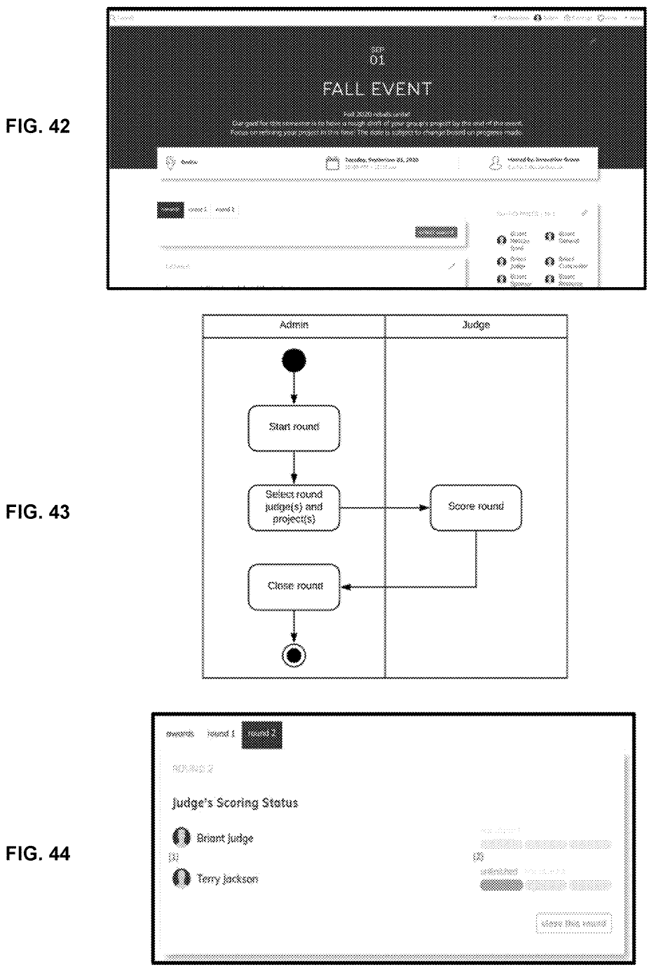

FIG. 42 depicts an embodiment of an Event page as it would appear for Hub Admin user.

### 10.3.1. Event Logistics

This section of the Event page displays the Event's start date, name, description, location, and host. Below is a list of functionalities with the user type (actor) that are available in this section.
1. Update Event Logistics (Admin)—By hovering over and clicking “manage”, the admin can update Event logistics entered during Event creation. An Event is updated by clicking on “Update Event”.
   a. Delete Event (Admin)—Upon clicking on “manage”, the admin can delete the Event by hovering over and clicking “Delete”.

### 10.3.2. Event Awards

This section of the Event page displays the Event's winner(s) once the admin has selected them.

Below is the default behavior of Event Awards.
All Event participants, except for the admin, should not be able to view this section of the Event page.

Below is a list of functionalities with the user type (actor) that are available in this section.
1. Select Award (Admin)—By hovering over and clicking on “select award”, the admin can select the Event winner(s). Upon clicking on it, the admin is prompted to choose how many winners the Event will have. The admin can choose up to 3 Event winners depending on how many projects submitted to the Event. Once the admin clicks on ‘submit,’ all Event participants will be able to see this section of the page as well as the Event winner(s).

### 10.3.3. Event Rounds

This section of the Event page displays the Event round(s) and Judges' scoring progress. Upon creating an Event, admins have the option to add judging to the Event. Adding judging to an Event opens up the ability to add rounds. Ultimately, it is up to the admin to decide how to define these rounds. Some examples of how rounds could be used are:
Split up an Event like a tournament, i.e.
   Round 1: quarterfinal
   Round 2: semifinal
   Round 3: final
Split up an Event with judging rooms, i.e.
   Round 1: judging room 1
   Round 2: judging room 2
Track progress of projects with different rounds of judging, i.e.
   Round 1: mid-semester
   Round 2: end-of-semester

Below is the default behavior of Event Rounds.
All participants, except for admins, should not be able to view rounds.
A round should not be open upon creating an Event.
A round should not include projects or Judges upon creating an Event.

Below is a list of functionalities with the user type (actor) that are available in this section.
1. Start Round (Admin)—By hovering over the blue ‘start this round’ box and clicking on it, the admin can start a round. By starting a round, the admin can:
   a. Select Round Judge(s)—Upon starting a round, the admin is prompted to select round Judge(s). These Judges must be a participant of the Event.
   b. Select Round Project(s)—Upon starting a round, the admin is prompted to select round project(s). These projects must be added to the Event by competitors.
2. Score Round (Judge)—By hovering over the blue ‘score round’ box and clicking on it, the Judge is directed to the Event round scoring page. From this page, the Judge can score project(s) by clicking on the project name. There are four scoring categories, with each category containing four prompts to guide the Judge in scoring a project. This score is calculated by adding up all the points received divided by the total number of points (60) available.
   a. Edit Evaluation (Judge)—After scoring a project, the Judge can go back and edit their evaluation. By hovering over “edit your evaluation” and clicking on it, the Judge can edit a project score. This function is no longer available once a round has been closed by the admin.
3. Close Round (Admin)—By hovering over “close this round” and clicking on it, the admin can close a round. Closing a round prevents Events Judges from being able to edit scores, but still allows them to view scores. Upon closing a round, the following functions become available:
   a. Re-open Round (Admin)—Upon closing a round, the admin is given the option to reopen a round by hovering and clicking on “re-open round”. Doing so allows Judges to edit round scores.
   b. Publish Scores (Admin)—Upon closing a round, the admin is given the option to public scores by hovering and clicking on “publish scores”. Doing so allows all Event participants to view this section of the page, as well as the scores given by Judges.

### 10.3.3.1 Event Rounds Process Overview

FIG. 43 depicts an embodiment of an overview for the process of running a round, with the following preconditions:
1. An Event has been created
2. Event has judging rounds
3. An Event has Judge(s) and competitor(s)
4. Project(s) have been added by competitor(s) to Event

FIG. 44 depicts an embodiment of an admin view of a round tab after adding Judges and projects to a round.

The list below outlines the information available in this view:
1. Judge Name(s)—The name(s) of the Judge(s) included in the round.
2. Judge's Scoring Status—This shows the progress the Judge has made in scoring. The three possible statuses are: not started, unfinished, and finished. Hovering over a Judge's scoring status gives a more detailed view of their progress made—as shown by the screenshot below.

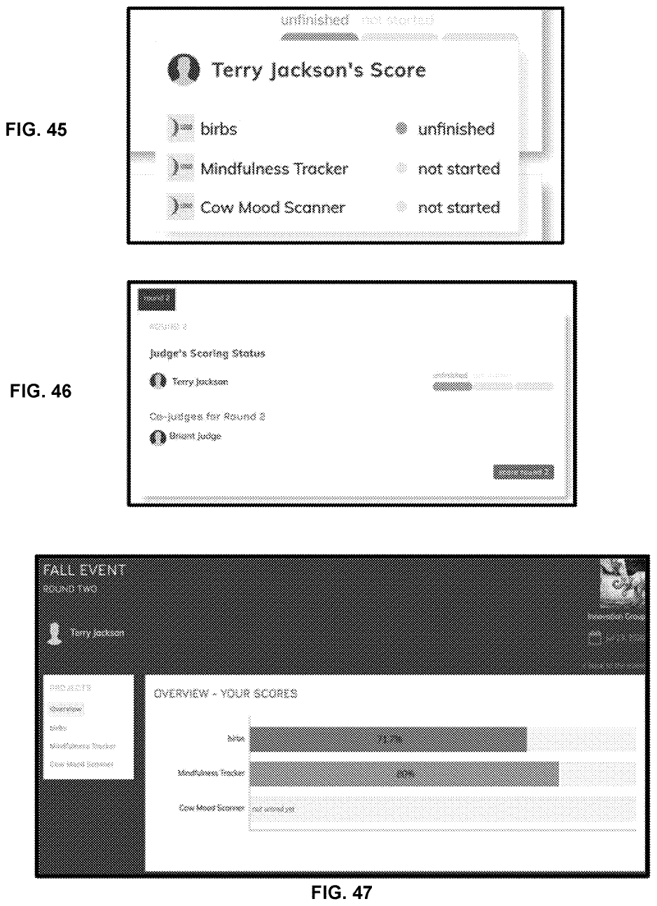

FIG. 45 depicts an embodiment of a Judge's round scoring progress.

### 10.3.3.2 Scoring Rounds

FIG. 46 depicts an embodiment of a Judge's view of a round.

From this view, a Judge can choose to score a round. In this instance, the Judge would click on ‘score round 2’ to score this round's projects. Clicking on ‘score round 2’ would direct the Judge to a score Overview Page as shown by the FIG. 47, depicts an embodiment of round scoring overview page displayed for a Judge user.

Under Overview, the Judge can view the projects they have scored, as well as the projects' overall score. Clicking on project names directs the Judge to the project's grading rubric (as shown by the screenshot below).

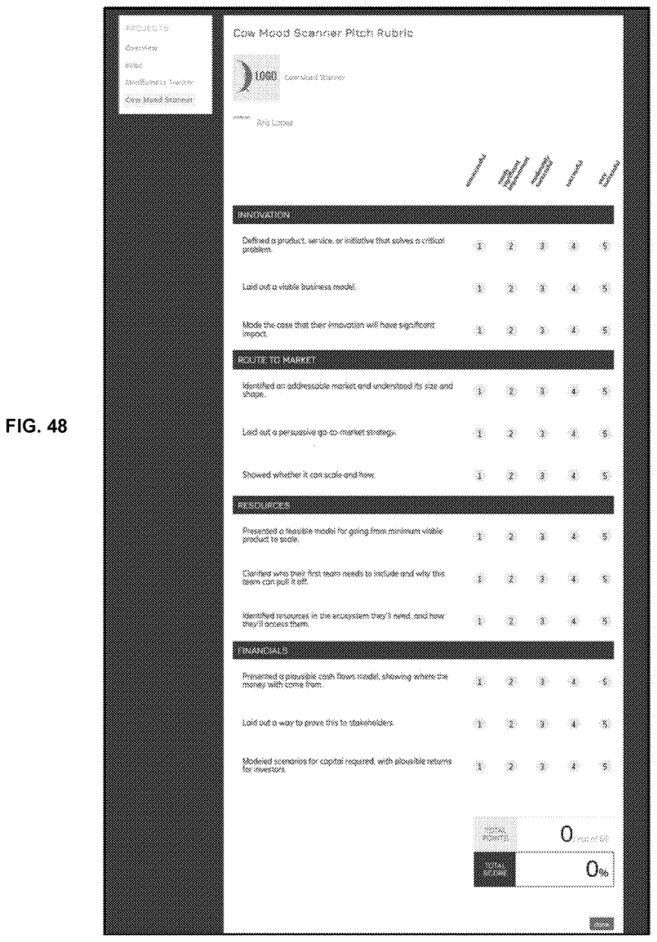

FIG. 48 depicts an embodiment of a project grading rubric displayed for a Judge user.

The current rubric (as shown in FIG. 48) is used across all projects to calculate a score. This score is calculated by adding up all the points received divided by the total number of points (60) available. There are four scoring categories (which details may change), with each category containing four prompts to guide the Judge in scoring a project. The scoring categories and their prompts include:
1. Innovation
   a. Defined a product, service, or initiative that solves a critical problem.
   b. Laid out a viable business model.
   c. Make the case that their innovation will have a significant impact.
2. Route To Market
   a. Identified an addressable market and understood its size and shape.
   b. Laid out a persuasive go-to-market strategy.
   c. Showed whether it can scale and how.
3. Resources
   a. Presented a feasible model for going from minimum viable product to scale.
   b. Clarified who their first team needs to include and why this team can pull it off.
   c. Identified resources in the ecosystem they'll need, and how they'll access them.
4. Financials
   a. Presented a plausible cash flows model, showing where the money with come from.
   b. Laid out a way to prove this to stakeholders.
   c. Modeled scenarios for the capital required, with plausible returns for investors.

The screenshot below is an example of how a score is calculated.

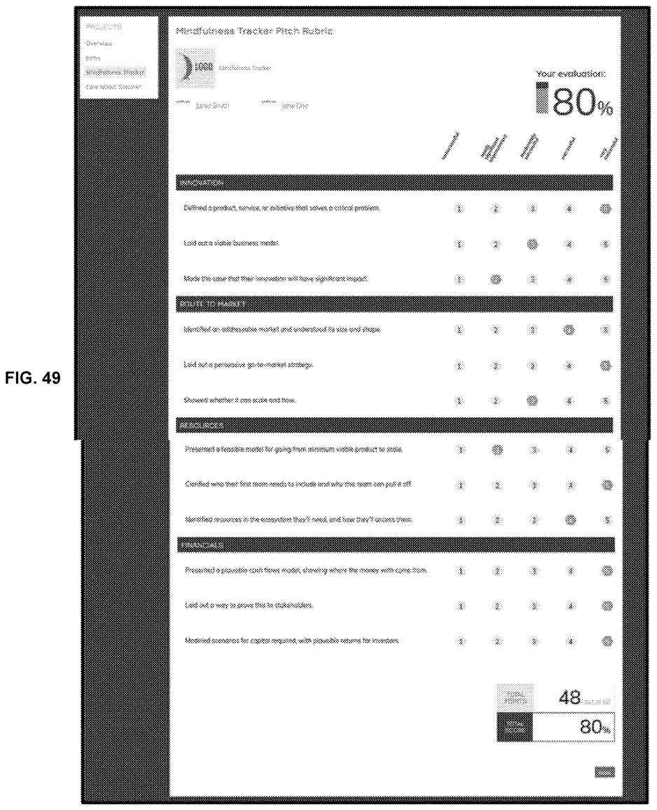

FIG. 49 depicts an embodiment of a graded rubric.

### 10.3.4. Event Details

This section of the Event page displays the Event details added by the admin. Below is a list of functionalities with the user type (actor) that are available in this section.
1. Edit Event Details (Admin)—By hovering over and clicking “edit details”, the admin can edit Event details. NOTE: This is different from the Event logistics added during Event creation.

### 10.3.5. Competitors

This section of the Event page displays the Event competitors and their projects. Below is a list of functionalities with the user type (actor) that are available in this section.
1. View Participant's Project (ALL)—By hovering over and clicking on the project logo or project name, Event participants are directed to the Project Profile.
2. Select Project (Competitor)—By hovering over and clicking on “select project”, the competitor can add a project to the Event page. This functionality is available if the competitor did not select a project upon joining the Event. If the competitor does not have an existing project, it will prompt the competitor to create one.
3. Change Project (Competitor)—By hovering over and clicking on “change project”, the competitor can change the project selected for the Event. Once a project has been selected for a round by the admin, the ability to change a project is no longer available.

### 10.3.6. Judges

This section of the Event page displays the Event Judges and their bios.

Below is the default behavior of Judges.
All participants, except for Admins and Judges, should not be able to view a Judge's bio.

Below is a list of functionalities with the user type (actor) that are available in this section.
1. Edit Bio (Judges)—By hovering over and clicking on “edit your bio”, Judges can edit their bio. This bio can be added (optional) by the Judge upon joining an Event. After a Judge adds their bio, the following functions become available:
   a. Publish Judge Bio (Admin)—By hovering over and clicking on “publish”, the admin can publish the Judge bio. Publishing the Judge bio allows all Event participants to view the Judge's bio. After the admin publishes Judge bio, the following function becomes available:
      i. Unpublish Judge Bio (Admin)—By hovering over and clicking on “unpublish”, the admin can unpublish the Judge bio. Doing so will prEvent all Event participants—except for admins and Judges—from being able to view the Judge bio.

### 10.3.7. Sponsors

This section of the Event page displays the Event sponsors and their information. Below is a list of functionalities with the user type (actor) that are available in this section.
1. Add Sponsor (Admin/Sponsor)—By hovering over and clicking on “add sponsor”, the users are able to add an Event sponsor. The actors are prompted to enter a sponsor company logo, name of the sponsor company, and sponsor website.
   a. Edit Sponsor (Admin/Sponsor)—Once sponsors have been added to the Event, users can edit sponsor details.

### 10.3.8. Supports

This section of the Event page displays the Event resources (supports) and their title. Below is a list of functionalities with the user type (actor) that are available in this section.
1. Edit Supports (Admin/Support)—By hovering over and clicking on “edit supports”, the users can edit the title of a support (resource). This title can be added (optional) by the resource upon joining the Event.

### 10.3.9. Posts

This section of the Event page displays posts created by Event participants. Below is a list of functionalities with the user type (actor) that are available in this section.
1. Write Post (ALL)—By writing on the post text box and clicking on “post”, the participant can publish a post to the Event page.
   a. Sticky (Admin)—Upon writing a post, the admin is given the option to sticky a post. By checking “Make it sticky” and clicking “post”, the admin publishes and sticky's a post. The admin is also able to sticky an existing post by going to the post, hovering over “ . . . ”, and clicking “sticky”.
      i. Unstick (Admin)—After publishing a post, the admin can unstick a post. By going to the stickied post, hovering over “ . . . ”, and clicking on “unstick”, the admin unsticks a post.
2. Delete Post (ALL)—By hovering over “ . . . ” and clicking “delete”, users can delete posts they have published. Doing so will delete the post from the Event page. NOTE: Admins can delete any posts, not just ones they have published.
3. Reply to Post (ALL)—By hovering and clicking on “reply”, users can reply to existing posts. Replying to a post will create a thread under the post.

### 10.3.10. Participants

This section of the Event page displays participants. Below is a list of functionalities with the user type (actor) that are available in this section.
1. Manage Participants (Admin)—By hovering over and clicking on the “pencil”, the ability to manage Event participants is opened for admins. Managing Event participants allows the admin to do the following:
   a. Invite Participants (Admin)—By hovering over and clicking on “Invite Participants”, the admin can invite participants to the Event. Upon clicking, the admin is prompted to select the participant role and enter email address(es). Multiple addresses can be entered and may be separated by commas (‘,’), semicolon (‘;’), and space (‘ ’). Admins can add a personal message clicking on “Personalize your invitation with a message” and a box will open up to add their message. Invitees will receive this message as an email with their invitation email. Clicking on ‘Send [Role] Invitation’ will send an invitation for the participant to join the Event. Below is a screenshot of the pop up to ‘Invite Participants’.

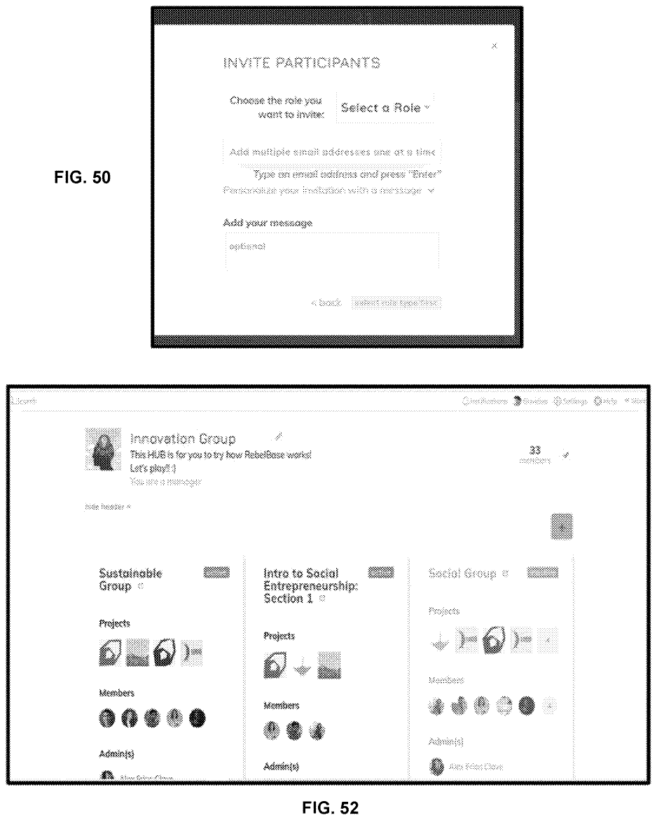

FIG. 50 depicts an embodiment of a dialog box to invite participants to an event.
2. Delete Invite (Admin)—The admin can delete existing Event participant invites. By clicking ‘delete’, the invite will no longer be valid.
3. Send a Nudge (Admin)—The admin can resend an existing Event invite by sending a ‘nudge’. This functionality allows the admin to remind a participant to accept the invite to the Event and join. By hovering over and clicking ‘send a nudge’, the admin will nudge the participant.
4. Change Participant Role (Admin)—By hovering over and clicking on ‘change role’, the admin can change an Event participant's role. The admin is prompted to choose a role from a dropdown list. Upon clicking ‘save’, the participant's role will be changed.

### 10.3.11. Hub Information

This section of the Event page displays the Hub's logo and name, as well as the current users' name and location.

### 10.3.12. Event Life Cycle

The below image represents the process flow from Event creation to completion.

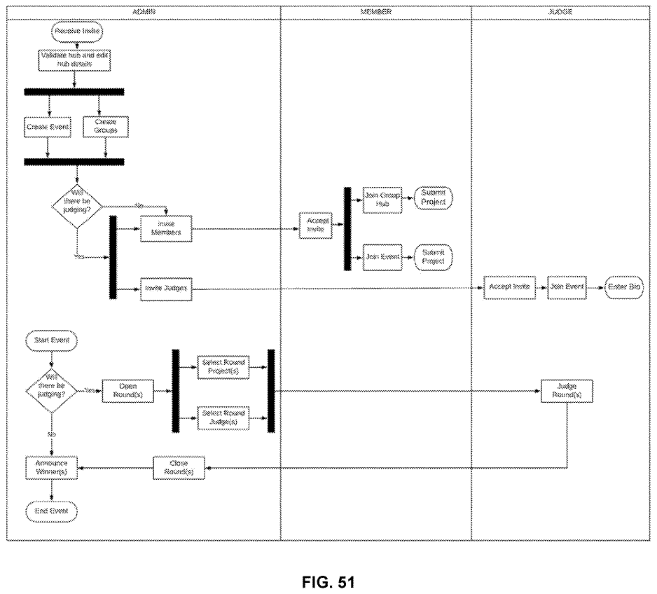

FIG. 51 depicts an embodiment of a process flow for event life cycle.

### 11. Hub Groups

The Groups enables the admin user to form groups of member users. The admin can add new members to any Group, customize and schedule Builders, and review submitted projects.

FIG. 52 depicts an embodiment of the Groups Overview page as displayed for user.

When Groups icon is clicked The Group Overview Page is shown as in FIG. 52. It has the following attributes: Hub Banner (explained in section 8.1.), Members (explained in section 8.3.) and Groups created in that Hub (as explained in the next section).

### 11.1. Create a New Group

To create a new Group click the + icon on the right. A create a Group dialog box appears.

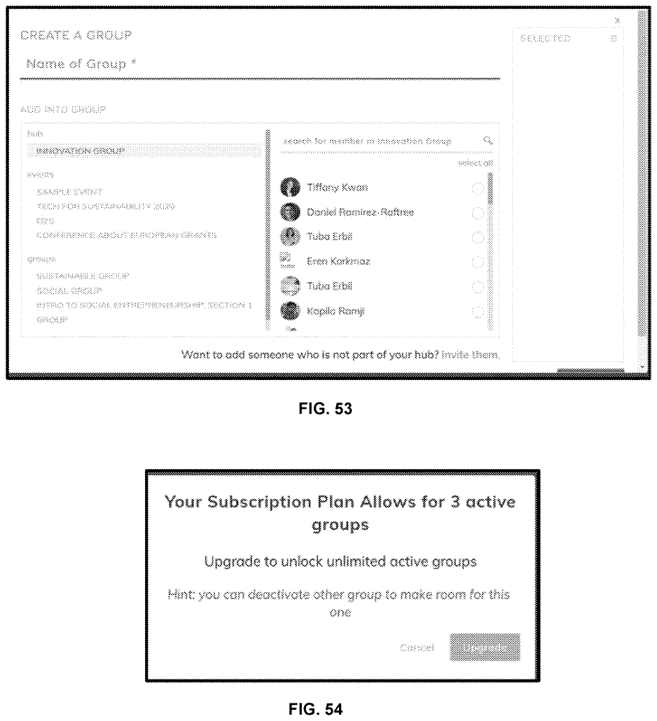

FIG. 53 depicts an embodiment of a dialog box to create a new group.

Type in the name of the Group. Add members from the Hub, Events, and existing Groups to the new Group.

Selected members can be viewed on the right side of the dialog box. If a user is not part of the Hub, the admin can invite them using the ‘invite them’ link at the bottom. Click create to create the Group. Click cancel to exit without creating a Group.

Admins can create more than one Group. The number of Groups that can be created is based on the subscription plan. If the admin attempts to create more Groups than allowed in their subscription, the below dialog box appears prompting the admin to upgrade their subscription pan. Click cancel to exit without upgrading.

FIG. 54 depicts an embodiment of a dialog box to upgrade subscription plan.

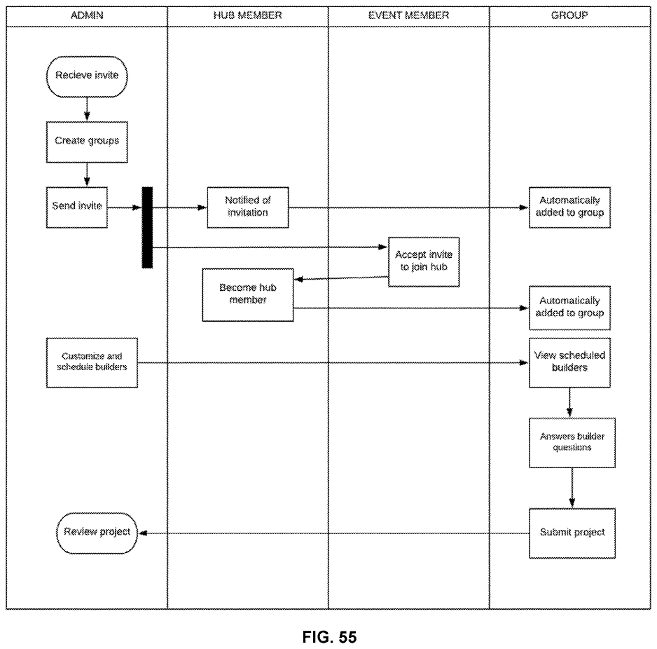

FIG. 55 depicts an embodiment of a process flow for inviting group members. The figure shows how each member from a different zone is added to the group:
1. The user receives an invite to join as an admin.
2. The admin creates Groups and sends invites to add to the Group.
3. If the invite is sent to a Hub member, they are automatically added to the Group.
4. If the invite is sent to an Event member who is not part of the Hub, an invitation to join the Hub is sent after which the member is automatically added to the Group.
5. The admin customizes and schedules Builders to the Group.
6. The Group members can view the scheduled Builders and will answer the Builder questions as per the schedule.
7. The Group members answer Builder questions and submit projects in the Group.
8. The admin reviews the submitted projects.

### 11.2. Deactivate/Delete Group

On the top right of each Group, the Hub admin can click the blue ‘active’ button, in the dropdown list click deactivate to deactivate the Group. Click delete to delete the Group

### 11.3. Activate/Delete Group

By clicking on the grey ‘inactive’ button, an admin can activate the Group or delete the Group.

### 11.4. View Group

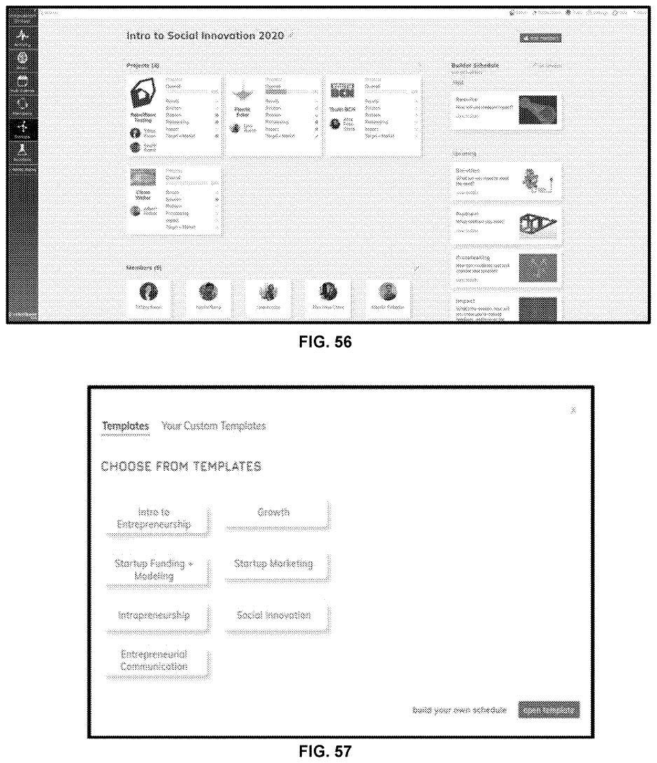

By hovering over the Group name and clicking on it, users are shown an expanded view of the Group—as shown in FIG. 56, which depicts an embodiment of a group page view with Projects, Members and Builder Schedule for Admin user.

The page above shows the projects submitted in the Group, the Group members, and scheduled Builders. Scroll down if required, to find the list of admins associated with the Group. Click on a project to view its Project Profile. Click a member to visit their profile.

### 11.4.1 Schedule Builders

Click the set schedule pencil edit icon to set Builder schedules for the Group. Using this, the admin can control which Builders the Group members can view.

The admin has an option to choose a template or customize and save their template.

FIG. 57 depicts an embodiment of default templates to choose from as Admin user.

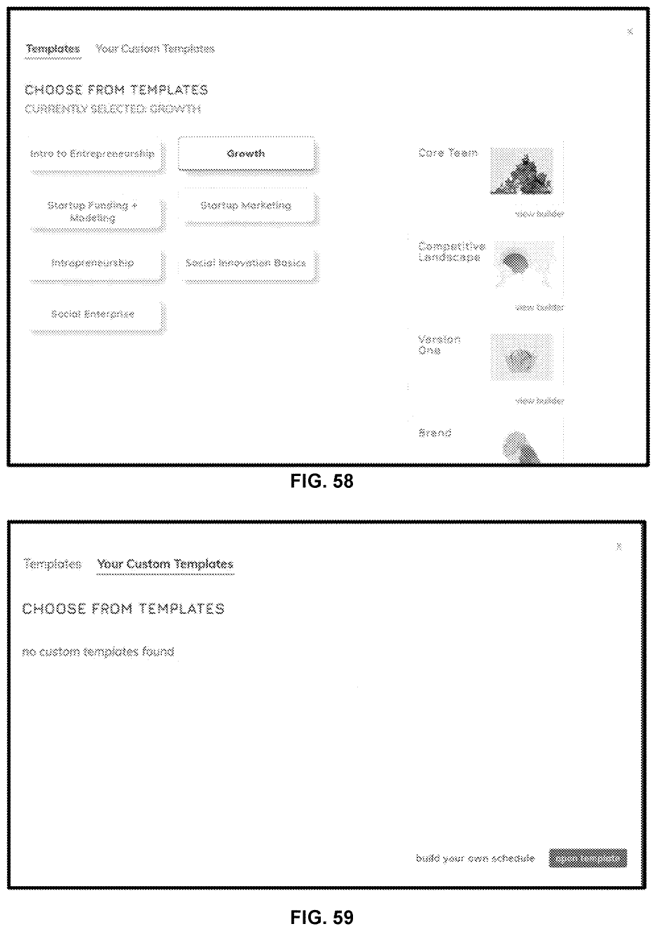

FIG. 58 depicts an embodiment of a chosen template with Builders shown on the right. Click on a template to view the Builders associated with it, on the right side as shown in FIG. 58. Only one template can be selected at a time. Click on ‘view Builder’ to view the Builder's modules.

Click ‘Your custom templates’ to view the saved custom templates. The admin can save any number of custom templates. The admin can select a custom template to set up the schedule.

FIG. 59 depicts an embodiment of a saved custom template page.

Once a template is decided, click the ‘open template’ button. The builder schedule page appears, similar to the below screenshot.

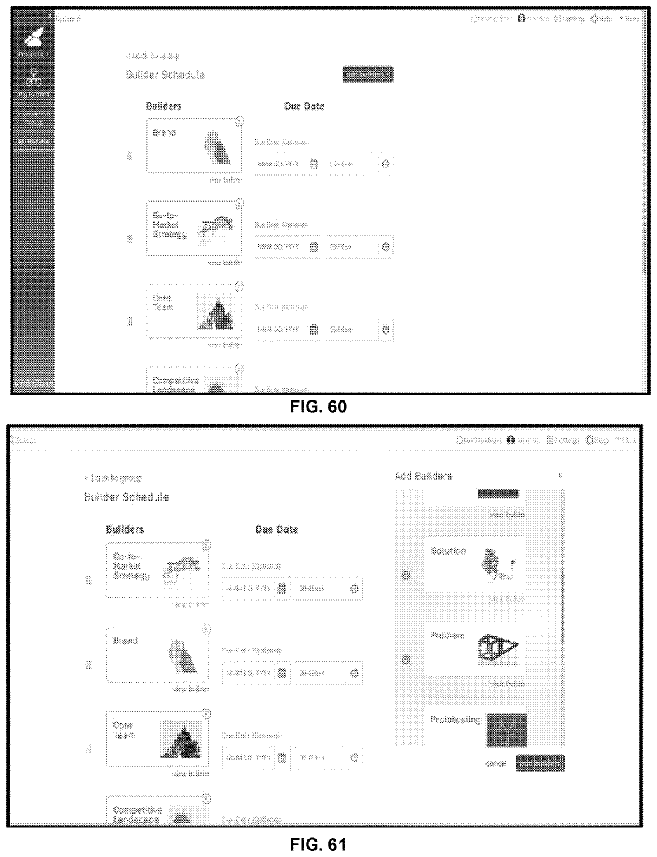

FIG. 60 depicts an embodiment of a Builder Schedule as displayed for Admin user.

Optionally, enter the due date and time for each Builder. The admin can drag the Builders or click the ‘add Builders’ button to add new Builders. On clicking ‘add Builder’ a list of Builders appears on the right pane. Click view Builder to view Builder modules. Select the Builders to add and click the ‘add Builders’ button. Click cancel to close.

FIG. 61 depicts an embodiment of Builders within the Schedule with Add Builders panel.

Use the close icon on the top-right corner of a Builder to remove a Builder. Only one schedule can be assigned to a Builder.

Scroll down to find the ‘save schedule’ button to save the entered schedule. Click ‘view templates’ to see the template dialog box to choose a different template.

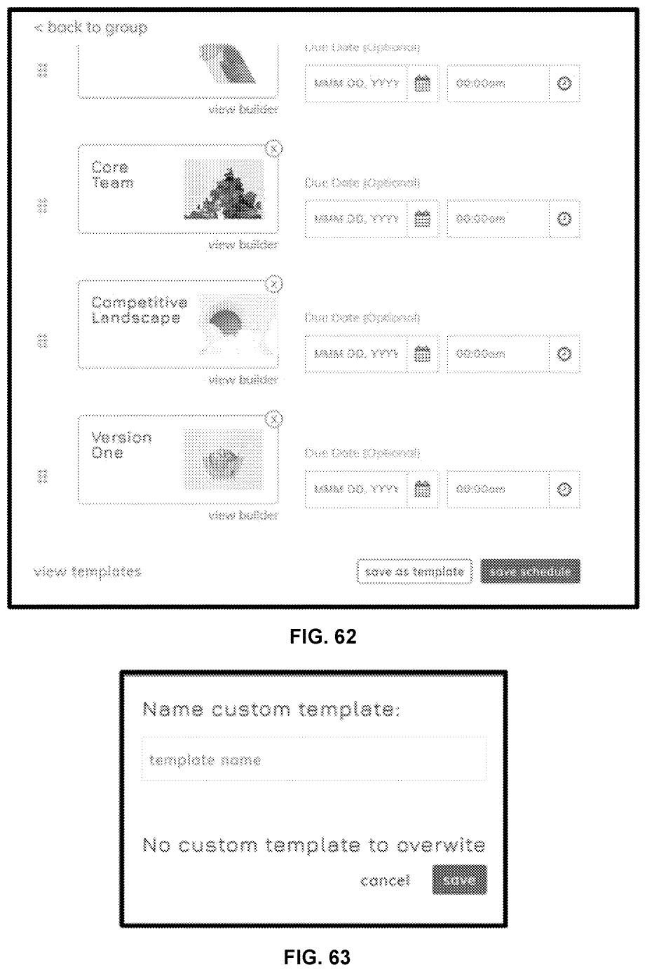

FIG. 62 depicts an embodiment of option to save schedule as a template.

Click ‘save as template’ to save the current schedule as a custom template. Enter a name for the custom template. The admin has an option to overwrite a custom template. Click save or click cancel to close without saving the template.

FIG. 63 depicts an embodiment of a dialog box to name or overwrite custom template.

In the ‘Choose from template’ dialog box, the admin has an option to build their own schedule. The below screenshot displays this.

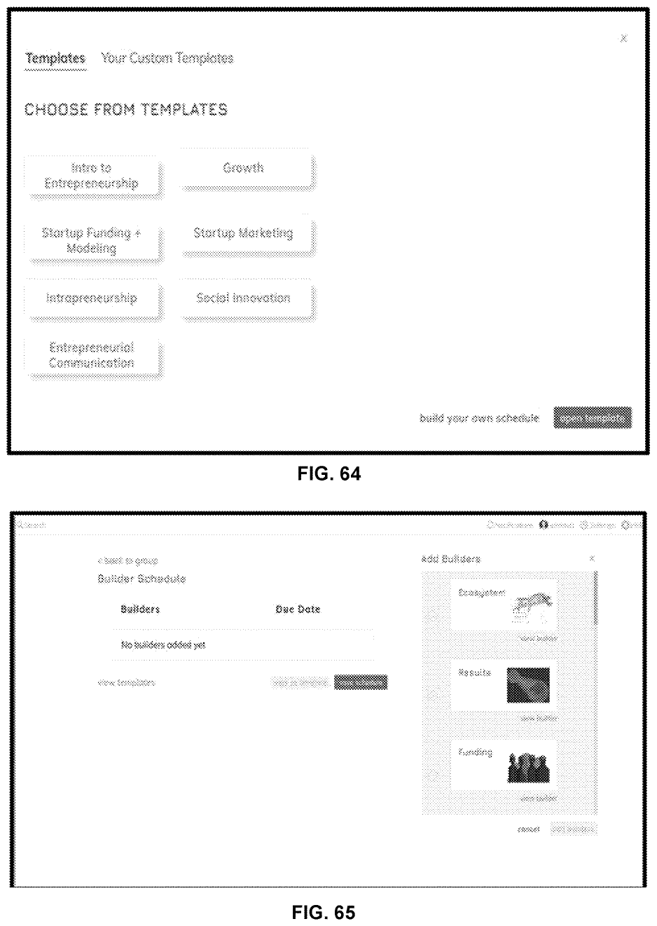

FIG. 64 depicts an embodiment of an option to build a Builder schedule.

Click ‘build your own schedule’. The Builder Schedule page appears. The admin can add the Builders of choice and schedule them. Scroll down to find the ‘save schedule’ button to save the entered schedule. Click ‘view templates’ to see the template dialog box to choose a different template. Click ‘save as template’ to save the current schedule as a custom template.

FIG. 65 depicts an embodiment of a Builder Schedule page with Add Builders panel.

### 11.4.2 Projects

On the Group page, the Projects section displays the projects submitted by the members. A count of the number of projects submitted is displayed in ( ) beside the Projects title.

The displayed projects have a progress bar associated with them. The progress bar displays the completion status.

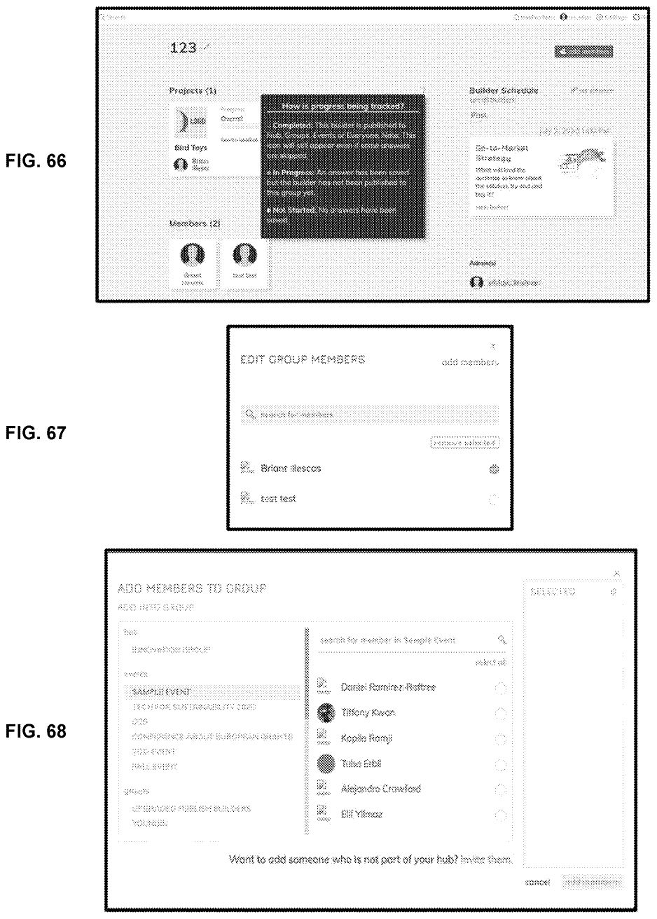

FIG. 66 depicts an embodiment of Help for user's project progress as being tracked.
Progress is tracked as ‘Completed’, if the Builder is published to Hub, Groups, Events, or everyone. This icon will still appear even if some answers are skipped.
Progress is tracked as ‘In Progress,’ if an answer has been saved but the Builder has not been published to the Group.
Progress is tracked as ‘Not Started,’ if no answer has been saved.

### 11.4.3. Members

Members section displays the Group members. Click edit members pencil icon to edit Group members. The ‘edit Group members’ dialog box appears. Search for a Group member using the search box. Select a member and click ‘remove selected’ to remove the selected member.

FIG. 67 depicts an embodiment of a dialog box to edit Group members.

Click add members to add a new member to the Group.

FIG. 68 depicts an embodiment of adding members to a Group.

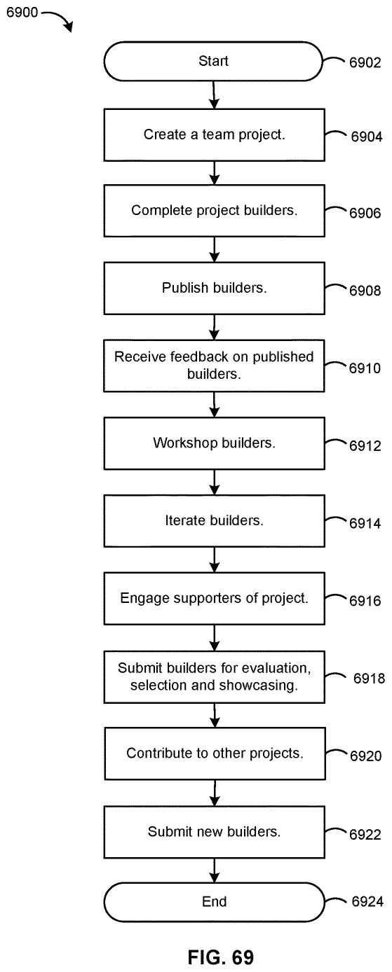

An exemplary embodiment of a method of operating the ILS 100 to both teach how to innovate and facilitate development of an innovation is depicted in FIG. 69. The method may be considered from the perspective of the Rebel's journey, with corresponding steps either as performed by components of the ILS 100 delivering the functionality of the steps to the user system (and thus have steps as correspondingly performed by these components, such as presenting corresponding interfaces to a user, receiving corresponding input from a user, etc.), or as performed by the user system 120 engaging the functionality of the ILS 100 described by the steps (and thus having steps as correspondingly performed by the user system 120, such as receiving and using interfaces provided to the user system by the ILS, providing inputs to the interfaces, etc.). The method begins at step 6902.

At step 6904, a team project is created. For example, this may include creating a project on the platform, and digitally inviting team members and Supporters to it.

For example, step 6904 may include some or all of the following. Step 6904 may include presenting, by the innovation learning system to at least one user system, an interface to create a project profile for use with the innovation learning system, the project profile being associated with the development of the innovation, the interface including an interface field to receive identification of at least one team member in addition to an owner of the project profile; and receiving, by the innovation learning system from the at least one user system, input to the interface for creating the project profile, the input identifying the at least one team member. Step 6904 may include presenting, by the innovation learning system to the user system, an interface to select one of a plurality of builder tracks, each of the builder tracks being related to a different aspect of developing an innovation and having a different ordered sequencer of builder modules related to the corresponding aspect; and receiving, by the innovation learning system from the user system, input to the interface to select one of the plurality of builder tracks. Step 6904 may also or instead include any other of the actions related to creating projects as discussed herein.

At step 6906, project builders are collaboratively completed. For example, this may include collaborating via the platform with team members and engaging Supporters as the Rebel follows the steps and complete the worksheets in a “project builder.” Each builder covers a part of the process of developing an innovative solution. For example, in the Problem builder, follow the guidance of the interactive tools to map out a dysfunctional system and frame an alternative to it.

For example, step 6906 may include some or all of the following. Step 6906 may include presenting, by the innovation learning system to a plurality of the user systems, an interface to an ordered sequence of builder modules. Presenting the interface to each of the builder modules may include presenting educational content related to a topic of the builder, wherein the topic of each builder relates to an aspect of teaching how to innovate, and presenting together at least one question related to the development of the innovation and an interface field to receive entry of an answer to the question from the user system. Step 6906 may also include receiving, by the innovation learning system from the plurality of user systems, input to the interface field for each of the builder modules representing the answer to the question, wherein for at least one of the builder modules, the input from at least one of the plurality of user systems modifies the input from at least another one of the plurality of user systems. The innovation learning system may receive the input to the interface field representing the answer to the question of at least one of the builder modules from a user system of an owner of a project profile including the at least one builder module, and from a user system of at least one team member of the project profile, wherein the input from one of the owner or team member modifies the input from the other of the owner or team member. Step 6906 may also or instead include any other of the actions related to completing project builders as discussed herein.

At step 6908, builders are published. For example, this may include publishing the results of the collaboration on each builder, so this becomes part of the project profile, either as a work-in-progress element or in its final form as a presentation element. The project will look different depending on the permissions of the viewer, and as the project evolves in the following steps, and deciding which modules to publish more narrowly or widely. “Rebel” users can choose to publish a given builder to everyone (so it becomes part of their searchable project profile, like a social media profile for an innovative solution), a group (like a course in which students develop innovations or an accelerator in which ventures build out their strategy), an event (such as a competition, demo day or project selection), or their team only (because this component is not yet ready to share, or contains a secret that should be shared only with support members of the team, like mentors and advisors).

For example, step 6908 may include some or all of the following. Step 6980 may include receiving an instruction from at least one of the user systems to publish at least one of the builder modules, and in response to receiving the instruction to publish the at least one builder module, publishing, by the innovation learning system, the at least one builder module, wherein publishing the at least one builder module includes providing access to content of the at least one builder module, including the received input to the interface field representing the answer to the question and any modifications thereof, to a selected group of users of the innovation learning system. The selected group of users may include at least one of: all users of the innovation learning system, a predetermined group of users associated with an educational course using the innovation learning system, a predetermined group of users associated with an event in the innovation learning system, or only team members of a project profile of the innovation learning system including the at least one builder module. Step 6908 may also or instead include any other of the actions related to publishing project builders as discussed herein.

At step 6910, feedback is received on published builders. For example, this may include eliciting input, resources, and questions relevant to a given project builder, from peers, mentors, and others in a group of users (for example, students and alumni in a course, or employees and leaders in key functions within an organization) or around the world (for example, within global and regional networks of universities and chambers of commerce that subscribe to the platform).

For example, step 6910 may include some or all of the following. Step 6910 may include presenting, by the innovation learning system to user systems of the selected group of users, an interface to the published at least one builder module, the interface including an interface field to receive entry of feedback on the published at least one builder module; and receiving, by the innovation learning system from the user system of at least one of the selected group of users, input to the interface field including the feedback on the published at least one builder module. Step 6910 may also or instead include any other of the actions related to receiving feedback on published project builders as discussed herein.

At step 6912, published builders are workshopped and receive critiques. For example, this may include presenting the published module, developed through online collaboration and feedback, for discussion during in-person sessions or using screen-sharing during video sessions. This may include participating in focused workshops during which users compare their work and offer each other suggestions and constructive criticism, often with the support of a facilitator or instructor; this leads to the subsequent iteration of the project module (step 6914), until it is finally published for purposes of evaluation/selection/project-portfolio. This module structure is designed to fill the gap left for project-based learning by conventional learning management systems.

At step 6914, builders are iterated. For example, this may include iterating each builder based on asynchronous and synchronous feedback throughout the process of researching, testing, and modeling your work and publishing new elements. Incorporate what's learned about the user, customer, competitive landscape, industry expert, funder, and others as you go through the process, revising earlier builders in the light of what's learned from later ones.

At step 6916, Supporters of project of the project are engaged. For example, this may include using the project profile and in-platform mechanisms like groups, events, and hubs to engage Supporters for the project as it evolves and demonstrates viability and potential. Fostering the alliance you need to thrive as an entrepreneurial Rebel, drawing from an “ecosystem” of supports. Scanning the skills and resources that members of your community, from alumni to community partners to co-workers, offer on the platform. Connecting based not on your capacity to serve outmoded systems, but instead around your endeavors to replace them with better ones. This enables connecting around your evolving capacity to build solutions to unsolved problems.

At step 6918, builders are submitted for evaluation, selection and showcasing. For example, this may include submitting the builders you have published for evaluation (in courses and trainings), scoring (in competitions), selection (for entry into an accelerator or program), and resource allocation (by funders such as investors, grantors, and organizational decision-makers). Using it as a digital portfolio piece that you control and evolve, an alternative to conventional professional networking profiles that show only what you contribute to existing (old) solutions. Demonstrating what you can accomplish as a leader and innovator both within an existing community (such as to alumni of your university or executives your organization) and to anyone with whom you share your public project profile.

For example, steps 6916 and 6918 may include some or all of the following. Steps 6916 and 6918 may include that the publishing the at least one builder publishes the at least one builder to an event of the innovation learning system. Steps 6916 and 6918 may include presenting, by the innovation learning system to a plurality of user systems of Judges for the event, an interface to judge at least one builder module published to the event, the interface including an interface field to receive a score on the builder module from the Judges using the plurality of user systems; and receiving, by the innovation learning system from the plurality of user systems of the Judges, input to the interface indicating the score for the at least one builder module published to the event. Steps 6916 and 6918 may include combining, by the innovation learning system, the scores from the plurality of Judges to create a combined score for the at least one builder module; and publishing, by the innovation learning system, the combined score for the at least one builder module. The event may include at least one builder module from a plurality of different project profiles of the innovation learning system, and these steps may include comparing, by the innovation learning system, the combined scores for the builder modules for each of the plurality of different project profiles; and selecting, by the innovation learning system, a specific one of the builder modules from the plurality of different project profiles as a winner of the event based on the comparing of the combined scores for the builder modules. The event may include a plurality of rounds, and the presenting the interface to the Judge and the receiving input indicating the score is repeated for each round. Steps 6916 and 6918 may also or instead include any other of the actions related to events as discussed herein.

At step 6920, other projects are contributed to. For example, to give back as a Peer, Alum, Manager, Mentor, Partner or Instructor, this may include availing oneself of opportunities to contribute to others' projects, giving your skills, expertise, guidance, and resources to others building solutions on the platform. Do this both as a peer, exchanging contributions with other innovators on the platform, and as an expert, participating by guiding or providing skills or resources to newer “Rebels” developing projects on the system.

At step 6922, new builders may be submitted. The RebelBase builders make the innovator's tools accessible as you use them, and since they're designed for people facing change, the tools themselves constantly evolve. If you develop a new model or have refined a methodology that you think would be useful to others facing change, you can submit it to the community along with your experience using it in your context. Moreover, if you've encountered the platform in one context, such as education, training or incubation, and want to bring it to your workplace, your neighborhood, or another community where people need a structured way to develop solutions designed to respond to change, RebelBase makes it easy to bring to those who need it using the free version, and offers tiered subscriptions that make it accessible to organizations and communities of various sizes. The method ends at step 6924.

In embodiments, a method of operating the ILS 100 to both teach how to innovate and facilitate development of an innovation may include only any subset of, or an alternative ordering of, the features depicted in or discussed above in regard to FIG. 69.

The ILS 100 teaches innovation and develops innovations in ways that are fundamentally different than traditional systems. The process of learning as you go, publishing, getting feedback and critique, and iterating is not possible using traditional systems. For this reason, RebelBase is used not only for remote applications, but also for in-person ones. In classrooms and at organizations, people use the platform to interact with each other in this iterative process.

The ILS 100 also provides an ecosystem that is fundamental different than found in traditional systems. The ILS 100 connects people developing solutions with the ecosystem of collaborators and resources that can make it possible to realize them, and to learn how to do so by doing. The system enables people to interact meaningfully around attacking broken systems by launching structured experiments to replace them. This creates an engagement of, interaction between, and cross-pollination of ideas, resources, and expertise among alumni, experts, and supporters in ways that does not occur in traditional system, such as at a conference, etc., where most of the energy is lost, instead of being channeled into an ongoing, living digital community and project collaboration space.

The ILS 100 can be used for hybrid and remote engagement, enabling of connective asynchronous interaction between synchronous uses, which is a large advantage. For example, the ILS has been used in a collaboration between faculty and students in five parts of the world, and that collaboration allowed us to trade models, resources, critiques, ideas, and the like in ways that could never have been done otherwise.

Additional embodiments of the ILS 100, and associated methods, as discussed herein, are possible. For example, any feature of any of the embodiments of these systems and methods described herein may be used in any other embodiment of these systems and methods. Also, embodiments of these systems and methods may include only any subset of the components or features of these systems and methods discussed herein

What is claimed is:

1. A method of operating an innovation development system, the method comprising:
providing accounts for the innovation development system, the accounts including accounts for members of a team of users;
providing a plurality of socket connections between at least one server and user systems of the team of users;
presenting, by the at least one server to the user systems, an interface page to a plurality of builder modules, wherein presenting the interface page to each builder module includes:
presenting educational content related to a plurality of topics of the builder module that provides a guide through steps of developing an innovation;
presenting a plurality of questions, each question related to a corresponding one of the plurality of topics and development of the innovation; and
presenting interface fields to receive entry of answers to the questions;
receiving simultaneous input to the interface fields from at least some of the plurality of user systems via the socket connections to generate the answers to the questions, and simultaneously displaying the input to the plurality of user systems via the socket connections without refreshing the interface page;
receiving, by the at least one server from at least one of the user systems, a selection of a group from a plurality of different groups of users to publish the answers to the questions for at least one of the plurality of builder modules, the plurality of different groups of users including a first group including the team of users, a second group including users for an event, and a third group including any public user;
receiving, by the at least one server via at least one of the socket connections, a request from a user in the selected group to view a project profile page of the team;
in response to the request, generating, by the at least one server via the socket connections, the project profile page having answers to the questions for which the user is a member of the selected group for that builder module, and an interface field to receive entry of feedback on the answers;
receiving, by the at least one server from the user via the socket connections, input to the interface field including the feedback on the answers;
displaying the received feedback on the profile page via the socket connections to at least one user system and at least one of the selected group of users, without refreshing the profile page; and
receiving, by the at least one server from at least one user system, a selection of a different one of the plurality of different groups of users to publish the answers to the questions for the at least one of the plurality of builder modules.

2. The method of claim 1, wherein the selected group of users includes at least one of:
all users of the innovation development system, a predetermined group of users associated with an innovation program using the innovation development system, a predetermined group of users associated with an event in the innovation development system, or only team members of a project profile of the innovation development system including the at least one builder module.

3. The method of claim 1, wherein the providing access to the interface including the answers to the questions related to the topics of the at least one builder module publishes the at least one builder module to an event of the innovation development system; and the method further comprises:
presenting, by the innovation development system to a plurality of user systems of judges for the event, an interface to judge the at least one builder module published to the event, the interface including an interface field to receive a score on the builder module from the judges using the plurality of user systems; and
receiving, by the innovation development system from the plurality of user systems of the judges, input to the interface indicating the score for the at least one builder module published to the event.

4. The method of claim 3, further comprising:
combining, by the innovation development system, the scores from the plurality of judges to create a combined score for the at least one builder module; and
publishing, by the innovation development system, the combined score for the at least one builder module.

5. The method of claim 4, wherein the event includes at least one builder module from a plurality of different project profiles of the innovation development system, and the method further comprises:
comparing, by the innovation development system, the combined scores for the builder modules for each of the plurality of different project profiles; and
selecting, by the innovation development system, a specific one of the builder modules from the plurality of different project profiles as a winner of the event based on the comparing of the combined scores for the builder modules.

6. The method of claim 5, wherein the event includes a plurality of rounds, and the presenting the interface to the judge and the receiving input indicating the score is repeated for each round.

7. The method of claim 1, further comprising:
presenting, by the innovation development system to at least one user system, an interface to create a project profile for use with the development system, the project profile being associated with the development of the innovation, the interface including an interface field to receive identification of at least one team member in addition to an owner of the project profile; and
receiving, by the innovation development system from the at least one user system, input to the interface for creating the project profile, the input identifying the at least one team member.

8. The method of claim 1, further comprising presenting, by the innovation development system to the user system, an interface to select one of a plurality of builder tracks, each of the builder tracks being related to a different aspect of developing an innovation and having a different ordered sequencer of builder modules related to the corresponding aspect; and
receiving, by the innovation development system from the user system, input to the interface to select one of the plurality of builder tracks.

9. The method of claim 1, wherein the providing the accounts for the innovation development system includes providing accounts for at least one supporter, wherein accounts for the team of users are for developing an innovation, and the account for the supporter is for providing input regarding a subject related to the innovation.

10. The method of claim 1, wherein the providing the plurality of socket connections includes providing at least one socket connection between the at least one server and at least one supporter system.

11. The method of claim 1, wherein the first group of users includes the team of users and the at least one supporter.

12. An innovation development system, comprising:
at least one processor;
a non-transitory machine-readable storage medium having program instructions, which when executed by the at least one processor cause a method of operating the innovation development system to be performed, the method including:
providing accounts for the innovation development system, the accounts including accounts for members of a team of users;
providing a plurality of socket connections between at least one server and user systems of the team of users;
presenting, by the at least one server to the user systems, an interface page to a plurality of builder modules, wherein presenting the interface page to each builder module includes:
presenting educational content related to a plurality of topics of the builder module that provides a guide through steps of developing an innovation;
presenting a plurality of questions, each question related to a corresponding one of the plurality of topics and development of the innovation; and
presenting interface fields to receive entry of answers to the questions;
receiving simultaneous input to the interface fields from at least some of the plurality of user systems via the socket connections to generate the answers to the questions, and simultaneously displaying the input to the plurality of user systems via the socket connections without refreshing the interface page;
receiving, by the at least one server from at least one of the user systems, a selection of a group from a plurality of different groups of users to publish the answers to the questions for at least one of the plurality of builder modules, the plurality of different groups of users including a first group including the team of users, a second group including users for an event, and a third group including any public user;
receiving, by the at least one server via at least one of the socket connections, a request from a user in the selected group to view a project profile page of the team;
in response to the request, generating, by the at least one server via the socket connections, the project profile page having answers to the questions for which the user is a member of the selected group for that builder module, and an interface field to receive entry of feedback on the answers;
receiving, by the at least one server from the user via the socket connections, input to the interface field including the feedback on the answers;
displaying the received feedback on the profile page via the socket connections to at least one user system and at least one of the selected group of users, without refreshing the profile page; and
receiving, by the at least one server from at least one user system, a selection of a different one of the plurality of different groups of users to publish the answers to the questions for the at least one of the plurality of builder modules.

13. The innovation development system of claim 12, wherein the selected group of users includes at least one of: all users of the innovation development system, a predetermined group of users associated with an innovation program using the innovation development system, a predetermined group of users associated with an event in the innovation development system, or only team members of a project profile of the innovation development system including the at least one builder module.

14. The innovation development system of claim 12, wherein the providing access to the interface including the answers to the questions related to the topics of the the at least one builder module publishes the at least one builder module to an event of the innovation development system; and the method further comprises:
presenting, by the innovation development system to a plurality of user systems of judges for the event, an interface to judge the at least one builder module published to the event, the interface including an interface field to receive a score on the builder module from the judges using the plurality of user systems; and
receiving, by the innovation development system from the plurality of user systems of the judges, input to the interface indicating the score for the at least one builder module published to the event.

15. The innovation development system of claim 14, the method further comprising:
combining, by the innovation development system, the scores from the plurality of judges to create a combined score for the at least one builder module; and
publishing, by the innovation development system, the combined score for the at least one builder module.

16. The innovation development system of claim 15, wherein the event includes at least one builder module from a plurality of different project profiles of the innovation development system, and the method further comprises:
comparing, by the innovation development system, the combined scores for the builder modules for each of the plurality of different project profiles; and
selecting, by the innovation learning system, a specific one of the builder modules from the plurality of different project profiles as a winner of the event based on the comparing of the combined scores for the builder modules.

17. At least one non-transitory machine-readable storage medium having program instructions, which when executed by at least one processor, cause a method of innovation development to be performed, the method including:
providing accounts for an innovation development system, the accounts including accounts for members of a team of users;
providing a plurality of socket connections between at least one server and user systems of the team of users;
presenting, by the at least one server to the user systems, an interface page to a plurality of builder modules, wherein presenting the interface page to each builder module includes:
presenting educational content related to a plurality of topics of the builder module that provides a guide through steps of developing an innovation;
presenting a plurality of questions, each question related to a corresponding one of the plurality of topics and development of the innovation; and
presenting interface fields to receive entry of answers to the questions;
receiving simultaneous input to the interface fields from at least some of the plurality of user systems via the socket connections to generate the answers to the questions, and simultaneously displaying the input to the plurality of user systems via the socket connections without refreshing the interface page;
receiving, by the at least one server from at least one of the user systems, a selection of a group from a plurality of different groups of users to publish the answers to the questions for at least one of the plurality of builder modules, the plurality of different groups of users including a first group including the team of users, a second group including users for an event, and a third group including any public user;
receiving, by the at least one server via at least one of the socket connections, a request from a user in the selected group to view a project profile page of the team;
in response to the request, generating, by the at least one server via the socket connections, the project profile page having answers to the questions for which the user is a member of the selected group for that builder module, and an interface field to receive entry of feedback on the answers;
receiving, by the at least one server from the user via the socket connections, input to the interface field including the feedback on the answers;
displaying the received feedback on the profile page via the socket connections to at least one user system and at least one of the selected group of users, without refreshing the profile page; and
receiving, by the at least one server from at least one user system, a selection of a different one of the plurality of different groups of users to publish the answers to the questions for the at least one of the plurality of builder modules.

18. The non-transitory machine-readable storage medium of claim 17,
wherein the selected group of users includes at least one of: all users of the innovation development system, a predetermined group of users associated with an innovation program using the innovation development system, a predetermined group of users associated with an event in the innovation development system, or only team members of a project profile of the innovation development system including the at least one builder module.

19. The non-transitory machine-readable storage medium of claim 17, wherein the providing the accounts for the innovation development system includes providing accounts for at least one supporter, wherein accounts for the team of users are for developing an innovation, and the account for the supporter is for providing input regarding a subject related to the innovation.

20. The non-transitory machine-readable storage medium of claim 17, wherein the providing the plurality of socket connections includes providing at least one socket connection between the at least one server and at least one supporter system.
